(19) United States
(12) Patent Application Publication
(10) Pub. No.: US 2020/0191497 A1
(43) Pub. Date: Jun. 18, 2020

(54) Deployable Radiator Devices, Systems, and Methods Utilizing Composite Laminates

(71) Applicant: Roccor, LLC, Longmont, CO (US)

(72) Inventors: Michael Hulse, Erie, CO (US); Mario Saldana, Thornton, CO (US); Steven Isaacs, Loveland, CO (US); Zachary McConnel, Centennial, CO (US)

(21) Appl. No.: 16/662,647

(22) Filed: Oct. 24, 2019

Related U.S. Application Data
(60) Provisional application No. 62/750,173, filed on Oct. 24, 2018.

(51) Int. Cl. F28D 15/02

(52) U.S. Cl. CPC F28D 15/0275; F28F 2013/006

(57) ABSTRACT

Deployable radiator devices, systems, and methods utilizing composite laminates are provide in accordance with various embodiments. For example, some embodiments include a deployable radiator system. The system may include one or more radiators and one or more thermally-conductive, bendable hinges. Each respective thermally-conductive, bendable hinge from the one or more thermally-conductive, bendable hinges may be coupled with a respective radiator from the one or more radiators. Each respective thermally-conductive, bendable hinge from the one or more thermally-conductive, bendable hinges may be configured to conduct heat to the respective radiator from the one or more radiators. Some embodiments include one or more heat pipes, which may be flat. Some embodiments include heat pipes with vapor channels and liquid channels configured in a same plane of the heat pipe. Methods of utilizing the systems and/or devices may be also provided.

### CROSS-REFERENCES TO RELATED APPLICATIONS

This application is a non-provisional patent application claiming priority benefit of U.S. provisional patent application Ser. No. 62/750,173, filed on Oct. 24, 2018 and entitled “DEPLOYABLE, COMPACT COMPOSITE RADIATORS WITH FLAT HEAT PIPES,” the entire disclosure of which is herein incorporated by reference for all purposes.

### BACKGROUND

Thermal management for different applications (e.g., space satellites, aerial vehicles, planetary or lunar exploration, terrestrial devices) include different challenges, such as thermal conduction and/or deployment. There may be a need for new tools and techniques to address thermal management for different applications.

### SUMMARY

Deployable radiator devices, systems, and methods utilizing composite laminates are provided in accordance with various embodiments. For example, some embodiments include a deployable radiator system. The system may include one or more radiators and one or more thermally-conductive, bendable hinges. Each respective thermally-conductive, bendable hinge from the one or more thermally-conductive, bendable hinges may be coupled with a respective radiator from the one or more radiators. Each respective thermally-conductive, bendable hinge from the one or more thermally-conductive, bendable hinges may be configured to conduct heat to the respective radiator from the one or more radiators.

In some embodiments, the one or more thermally-conductive, bendable hinges include one or more strain energy components. The one or more strain energy components may include one or more high-strain composite laminates. The one or more high-strain composite laminates may include one or more curved regions for a deployed state of the respective radiator. The one or more high-strain composite laminates may include an asymmetric composite laminate that changes shape with a temperature change. In some embodiments, the one or more thermally-conductive, bendable hinges includes one or more thermally conductive composite laminates.

In some embodiments, each of the one or more radiators includes one or more thermally conductive layers. The one or more thermally conductive layers may include one or more carbon layers. The one or more carbon layers may include at least one or more graphite layers or one or more graphene layers. At least the one or more graphite layers or the one or more graphene layers may include at least one or more pyrolytic graphite layers or one or more pyrolytic graphene layers. In some embodiments, the one or more of the one or more thermally conductive layers of the one or more radiators extend to form part of the one or more thermally-conductive, bendable hinges.

In some embodiments, at least one of the one or more radiators include one or more flat heat pipes. The one or more flat heat pipes may be embedded between one or more thermally conductive layers of the at least one radiator. The one or more flat heat pipes may be coupled with a surface of the at least one radiator.

Some embodiments include one or more heat pipes that are coupled with the one or more radiators utilizing the one or more thermally-conductive, bendable hinges. The one or more heat pipes may be configured to couple with one or more heat sources. Each of the one or more heat pipes may include a vapor layer and a liquid layer; the vapor layer and the liquid layer may be positioned within a same plane of the heat pipe. The one or more heat pipes may include one or more slotted wicks. The one or more heat pipes may include one or more slotted ribs; the one or more slotted ribs may support one or more of the slotted wicks. The one or more slotted wicks may include a titanium foam. In some embodiments, the one or more heat pipes include one or more through holes configured to couple the one or more heat pipes with the one or more heat sources.

Some embodiments include one or more strain energy components coupled with the one or more radiators and configured to deploy the one or more radiators. The one or more strain energy components may include at least one or more foldable struts or one or more tape springs. Some embodiments include one or more thermal switches positioned to control a flow of heat to the one or more radiators.

Some embodiments include a heat pipe device. The device may include a first containment layers and a second containment layer. The device may include a vapor layer formed between the first containment layer and the second containment layer. The device may include a liquid layer formed between the first containment layer and the second containment layer. The vapor layer and the liquid layer may be within a same plane of the heat pipe device.

Some embodiments of the device include one or more slotted wicks. Some embodiments include one or more slotted ribs; the one or more slotted ribs may support one or more of the slotted wicks. The one or more slotted wicks may include a titanium foam. Some embodiments include one or more through holes configured to couple the heat pipe device with one or more heat sources.

Some embodiments include a method that may include deploying a radiator coupled with a thermally-conductive, bendable hinge utilizing one or more strain energy components. In some embodiments, the hinge may provide the strain energy for deployment. Some embodiments may utilize a strain energy component separate from the thermally-conductive, bendable hinge. In some embodiments, heat may be conducted from a heat source to the radiator. In some embodiments, one or more thermal switches may be utilized to control the flow of heat from the heat source to the radiator.

In some embodiments of the method, the heat passes from the heat source to a first flat heat pipe. The first flat heat pipe may be coupled with the thermally-conductive, bendable hinge, for example, to facilitate the heat passing to a second flat heat pipe, which may be coupled with the radiator. In some embodiments, the radiator may include multiple pyrolytic graphite sheets. Some embodiments may utilize variations on these components to facilitate deployment of the device along with radiating heat that originates from a heat source. In some embodiments, the heat pipes may be constructed such that a vapor layer and a liquid layer are in a same plane of the heat pipe.

Some embodiments include methods, systems, and/or devices as described in the specification and/or shown in the figures.

The foregoing has outlined rather broadly the features and technical advantages of embodiments according to the disclosure in order that the detailed description that follows may be better understood. Additional features and advantages will be described hereinafter. The conception and specific embodiments disclosed may be readily utilized as a basis for modifying or designing other structures for carrying out the same purposes of the present disclosure. Such equivalent constructions do not depart from the spirit and scope of the appended claims. Features which are believed to be characteristic of the concepts disclosed herein, both as to their organization and method of operation, together with associated advantages will be better understood from the following description when considered in connection with the accompanying figures. Each of the figures is provided for the purpose of illustration and description only, and not as a definition of the limits of the claims.

### BRIEF DESCRIPTION OF THE DRAWINGS

A further understanding of the nature and advantages of different embodiments may be realized by reference to the following drawings. In the appended figures, similar components or features may have the same reference label. Further, various components of the same type may be distinguished by following the reference label by a dash and a second label that distinguishes among the similar components. If only the first reference label is used in the specification, the description is applicable to any one of the similar components having the same first reference label irrespective of the second reference label.

FIG. 1A shows a system and/or device in accordance with various embodiments.

FIG. 1B shows a system and/or device in accordance with various embodiments.

FIG. 1C shows a system and/or device in accordance with various embodiments.

FIG. 1D shows a system and/or device in accordance with various embodiments.

FIG. 2A shows a system and/or device in accordance with various embodiments

FIG. 2B shows a system and/or device in accordance with various embodiments.

FIG. 3A shows aspects of devices in accordance with various embodiments.

FIG. 3B shows aspects of a device in accordance with various embodiments.

FIG. 3C shows aspects of a device in accordance with various embodiments.

FIG. 4A shows aspects of a device in accordance with various embodiments.

FIG. 4B shows aspects of a device in accordance with various embodiments.

FIG. 5A shows aspects of devices in accordance with various embodiments.

FIG. 5B shows aspects of devices in accordance with various embodiments.

FIG. 6A shows aspects of a device in accordance with various embodiments.

FIG. 6B shows aspects of devices in accordance with various embodiments.

FIG. 6C shows aspects of a device in accordance with various embodiments.

FIG. 6D shows aspects of a device in accordance with various embodiments.

FIG. 6E shows aspects of a device in accordance with various embodiments.

FIG. 7A shows aspects of a system and/or device in accordance with various embodiments.

FIG. 7B shows aspects of a system and/or device in accordance with various embodiments.

FIG. 7C shows aspects of a system and/or device in accordance with various embodiments.

FIG. 7D shows aspects of a system and/or device in accordance with various embodiments.

FIG. 8A shows aspects of a system and/or device in accordance with various embodiments.

FIG. 8B shows aspects of a system and/or device in accordance with various embodiments.

FIG. 8C shows aspects of a system and/or device in accordance with various embodiments.

FIG. 9A shows aspects of a device in accordance with various embodiments.

FIG. 9B shows aspects of a device in accordance with various embodiments.

FIG. 9C shows aspects of a device in accordance with various embodiments.

FIG. 9D shows aspects of a device in accordance with various embodiments.

FIG. 10 shows a flow diagram of a method in accordance with various embodiments.

### DETAILED DESCRIPTION

This description provides embodiments, and is not intended to limit the scope, applicability or configuration of the disclosure. Rather, the ensuing description will provide those skilled in the art with an enabling description for implementing embodiments of the disclosure. Various changes may be made in the function and arrangement of elements.

Thus, various embodiments may omit, substitute, or add various procedures or components as appropriate. For instance, it should be appreciated that the methods may be performed in an order different than that described, and that various stages may be added, omitted or combined. Also, aspects and elements described with respect to certain embodiments may be combined in various other embodiments. It should also be appreciated that the following systems, devices, and methods may individually or collectively be components of a larger system, wherein other procedures may take precedence over or otherwise modify their application.

Deployable radiator devices, systems, and methods utilizing composite laminates are provide in accordance with various embodiments. For example, some embodiments include a deployable radiator system. The system may include one or more radiators and one or more thermally-conductive, bendable hinges. Each respective thermally-conductive, bendable hinge from the one or more thermally-conductive, bendable hinges may be coupled with a respective radiator from the one or more radiators. Each respective thermally-conductive, bendable hinge from the one or more thermally-conductive, bendable hinges may be configured to conduct heat to the respective radiator from the one or more radiators. Some embodiments include one or more heat pipes, which may be flat. Some embodiments include flat heat pipes with vapor channels and liquid channels configured in a same plane of the heat pipe. Methods of utilizing the systems and/or devices may be also provided.

For example, some embodiments include deployable, compact composite radiators. Some embodiments include a deployable radiator with embedded flat heat pipes, which may include titanium/water heat pipes. The deployable radiator may include one or more flat heat pipes that may be coupled with one or more heat sources. These flat heat pipes then may interface with the deployable radiator via a high-strain composite (HSC) hinge that may serve as the deploying mechanism and deployed structural element. The radiating section may be made from pyrolytic graphite sheets with flat heat pipes embedded to enhance thermal conductivity.

Some radiators in accordance with various embodiments function by conducting heat away from a heat source, such as a spacecraft, in a highly conductive flexible thermal blanket to increase radiative surface area available to the heat source. The flexible blanket may include pyrolytic graphite sheets (PGS) inside of a polymer encapsulant (e.g., Kapton, Au-coated Teflon) laminated together with pressure sensitive adhesive. Embodiments may be applicable to a variety of different applications such as space satellites, aerial vehicles, planetary or lunar exploration, and/or terrestrial devices. Furthermore, while embodiments generally include one or more radiators that may be configured to radiate heat, these components and/or others may also transfer heat through other processes, such as conduction and/or convection.

Some embodiments may facilitate the use of higher-powered engines, such as Stirling converters, for different applications, include but not limited to space missions. Some embodiments may provide for a more compact, stowable radiator by increasing radiator efficiency with embedded heat pipes. Some embodiments may reduce cold side temperatures of engines by reducing contact resistance with an integral interface. Some embodiments may be scalable.

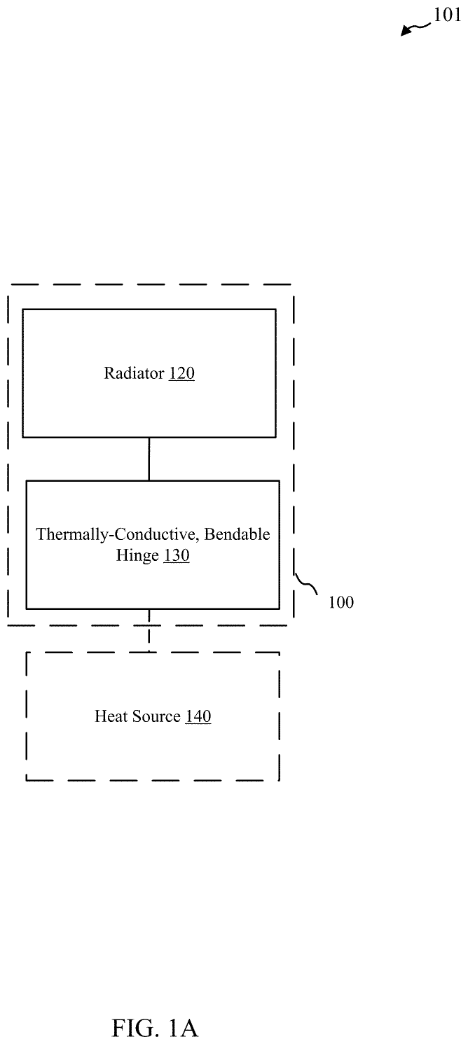

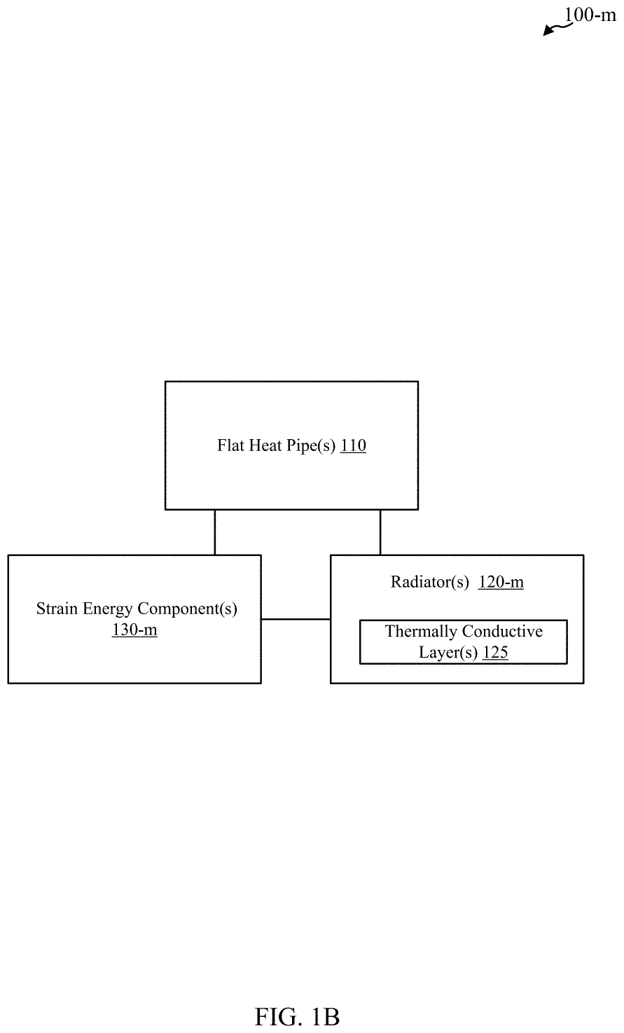

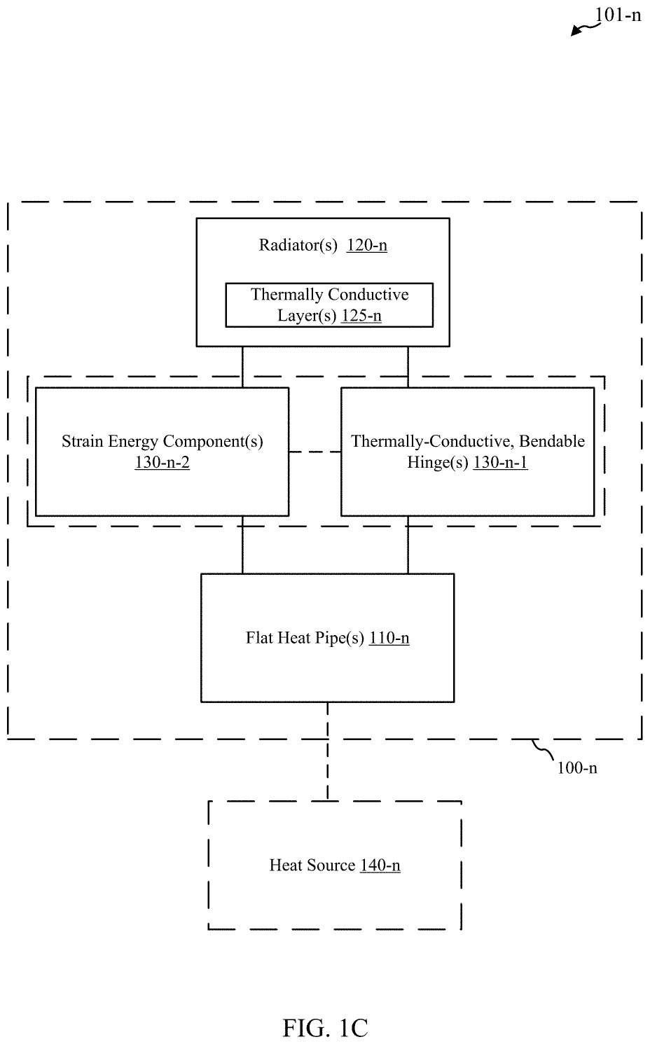

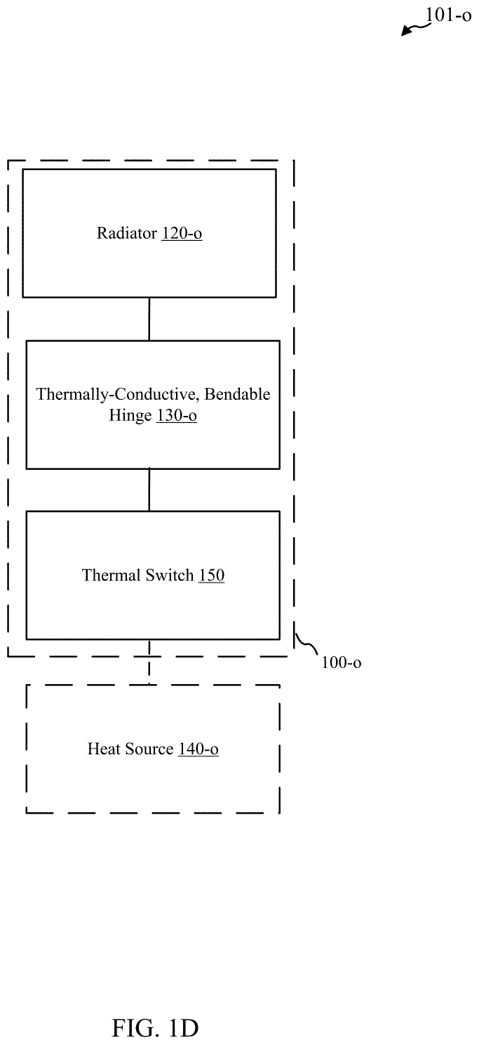

Turning now to FIG. 1A, a deployable radiator system 101 is provided in accordance with various embodiments. The system 101 may include one or more radiators 120 and one or more thermally-conductive, bendable hinges 130. System 101 may also include one or more heat sources 140. Each respective thermally-conductive, bendable hinge from the one or more thermally-conductive, bendable hinges 130 may be coupled with a respective radiator from the one or more radiators 120. Each respective thermally-conductive, bendable hinge from the one or more thermally-conductive, bendable hinges 130 may be configured to conduct heat to the respective radiator from the one or more radiators 120. For example, heat may be conducted from the one or more heat sources 140. The one or more radiators 120 and the one or more thermally-conductive, bendable hinges 130 may be referred to as a deployable radiator device 100.

In some embodiments of system 101, the one or more thermally-conductive, bendable hinges 130 include one or more strain energy components. The one or more strain energy components may include one or more high-strain composite laminates. The one or more high-strain composite laminates may include one or more curved regions for a deployed state of the respective radiator 120. The one or more high-strain composite laminates may include an asymmetric composite laminate that changes shape with a temperature change. In some embodiments, the one or more thermally-conductive, bendable hinges 130 include one or more thermally conductive composite laminates.

In some embodiments of system 101, each of the one or more radiators 130 includes one or more thermally conductive layers. The one or more thermally conductive layers may include one or more carbon layers. The one or more carbon layers may include at least one or more graphite layers or one or more graphene layers. At least the one or more graphite layers or the one or more graphene layers may include at least one or more pyrolytic graphite layers or one or more pyrolytic graphene layers. In some embodiments, the one or more of the one or more thermally conductive layers of the one or more radiators 120 extend to form part of the one or more thermally-conductive, bendable hinges 130. In some embodiments, the one or more thermally-conductive, bendable hinges 130 form living hinges.

In some embodiments of system 101, at least one of the one or more radiators 120 includes one or more flat heat pipes. The one or more flat heat pipes may be embedded between one or more thermally conductive layers of the at least one radiator 120. The one or more flat heat pipes may be coupled with a surface of the at least one radiator 120.

Some embodiments of system 101 include one or more heat pipes that are coupled with the one or more radiators 120 utilizing the one or more thermally-conductive, bendable hinges 130. The one or more heat pipes may be configured to couple with the one or more heat sources 140. Each of the one or more heat pipes may include a vapor layer and a liquid layer; the vapor layer and the liquid layer may be positioned within a same plane of the heat pipe. The one or more heat pipes may include one or more slotted wicks. The one or more heat pipes may include one or more slotted ribs; the one or more slotted ribs may support one or more of the slotted wicks. The one or more slotted wicks may include a titanium foam. In some embodiments, the one or more heat pipes include one or more through holes configured to couple the one or more heat pipes with the one or more heat sources 140.

Some embodiments of system 101 include one or more strain energy components coupled with the one or more radiators 120 and configured to deploy the one or more radiators 120. The one or more strain energy components may include at least one or more foldable struts or one or more tape springs. Some embodiments include one or more thermal switches positioned to control a flow of heat to the one or more radiators 120.

Turning now to FIG. 1B, a device 100-m is provided in accordance with various embodiments. Device 100-m may be referred to as a passively deployable thermal device and/or a passively deployable radiator device in some embodiments. Device 100-m may be an example of device 100 of FIG. 1A. Device 100-m may also be referred to as a deployable, compact composite radiator with flat heat pipes in some embodiments. The deployable radiator device 100-m may include: one or more radiator 120-m that may include one or more thermally conductive layers 125; one or more flat heat pipes 110; and/or one or more strain energy components 130-m configured to deploy passively the respective radiators 120-m. Some embodiments may also deploy passively one or more of the one or more of the flat heat pipes 110. The one or more thermally conductive layers 125 may include one or more carbon layers. The one or more carbon layers may include at least one or more graphite layers or one or more graphene layers. At least the one or more graphite layers or the one or more graphene layers may include at least one or more pyrolytic graphite sheets or one or more pyrolytic graphene sheets.

In some embodiments of device 100-m, the one or more strain energy components 130-m include one or more high-strain composite (HSC) hinges that may be coupled with the one or more flat heat pipes 110. The one or more high-strain composite hinges may be configured with one or more curved regions when deployed. The one or more high-strain composite hinges include an asymmetric composite laminate configured to change shape when a change in temperature occurs. The one or more strain energy components 130-m may be an example of the thermally-conductive, bendable hinges 130 of FIG. 1A. The one or more thermally-conductive, bendable hinges 130-m may form living hinges.

In some embodiments of device 100-m, each of the one or more high-strain composite hinges couples two flat heat pipes from the one or more heat pipes 110. The two flat heat pipes may include a first heat pipe that may be coupled with the radiator 120-m, such as being embedded within the radiator 120-m between two or more of the carbon sheets, such as pyrolytic graphite sheets. In some embodiments, the first heat pipe may be coupled with a surface of the radiator 120-m. The second flat heat pipe may be configured to couple with a heat source. In some embodiments, the second flat heat pipe may include a through hole, which may be configured to facilitate bolting the passively deployable radiator device 100-m through the second flat heat pipe to the heat source.

In some embodiments of device 100-m, the flat heat pipe(s) 110 may include containment layers along with internal porous layers that may form a vapor layer and a liquid layer. In some embodiments, the liquid layer and the vapor layer are within the same plane of the flat heat pipe 110. Some embodiments may utilize a slotted wicking structure that may be supported by a slotted rib. Some embodiments may include a through hole or pass through to facilitate coupling the flat heat pipe 110 with a heat source. In some embodiments, the flat heat pipe(s) 110 may be formed from titanium and charged with water, though other materials may be utilized.

In some embodiments of device 100-m, the one or more strain energy components 130-m include one or more thermally conductive composite laminates with sufficient strain energy to deploy passively the radiator 120-m and/or one or more of the one or more of the flat heat pipes 110. The one or more thermally conductive composite laminates may include one or more high-strain laminate layers. While some embodiments may utilize an HSC hinge as the strain energy component 130-m, some embodiments may utilize other strain energy components 130-m such as a tape spring; thermally conductive layers may be utilized to thermally couple different components across the tape spring. The one or more tape springs may include a beryllium-copper structure. The one or more tape springs may include a high-strain composite material; in some embodiments, thermally conductive materials may be integrated into the tape spring.

In some embodiments of device 100-m, the one or more thermally conductive layers 125 of the radiator 120-m include multiple thermally conductive layers, such as pyrolytic graphite sheets, bonded with each other. The multiple thermally conductive layers 125 may be bonded with each other utilizing an adhesive. The multiple thermally conductive layers 125 may be bonded with each other utilizing diffusion bonding; one or more metal layers, such as one or more stainless steel layers formed as foils and/or meshes, may be positioned between the multiple thermally conductive layers 125. In some embodiments, the one or more thermally conductive layers 125 are encapsulated. In some embodiments, one or more of the flat heat pipes 110 may be formed between two or more of the thermally conductive layers 125, such that the layers form a composite overwrap pressure bearing vessel; the thermally conductive layers 125 may act as containment layers for the flat heat pipe 110 in some cases.

In some embodiments of device 100-m, the one or more thermally conductive layers 125 are continuous across a hinge region defined with respect to the one or more strain energy components 130-m. The one or more thermally conductive layers 125 may include multiple thermally conductive layers 125 that remain separate across at least a portion of the hinge region.

Some embodiments of device 100-m include one or more coatings applied to one or more surfaces of the one or more thermally conductive layers 125, the radiator 120-m in general, the one or more strain energy components 130-m, and/or the one or more flat heat pipes 110. The one or more coatings may include at least a high emissivity coating or a low absorption coating.

FIG. 1C provides an example of a system 101-n in accordance with various embodiments. System 101-n may be an example of system 101 of FIG. 1A and may include a device 100-n that may be an example of device 100 of FIG. 1A and/or device 100-m of FIG. 1B. Device 100-n may include one or more radiators 120-n that may include one or more thermally conductive layers 125-n. One or more thermally-conductive, bendable hinges 130-n-1 may couple the one or more radiators 120-n with one of more flat heat pipes 110-n. Device 100-n may include one or more strain energy components 130-n-2. In some embodiments, the one or more strain energy components 130-n-2 may form part of the one or more thermally-conductive bendable hinge(s) 130-n-1. In some embodiments, the one or more strain energy components 130-n-2 include components separate from the one or more thermally-conductive, bendable hinges 130-n-1; for example, the one or more strain energy components 130-n-2 may include one or more foldable struts or one or more tape springs. The one or more heat pipes 110-n may facilitate coupling the device 100-n with one or more heat sources. The coupling may provide both a mechanical coupling and a thermal coupling between these components.

FIG. 1D shows another example of a system 101-o in accordance with various embodiments. System 101-o may be an example of system 100 of FIG. 1A and may include a device 100-o that may be an example of device 100 of FIG. 1A and/or device 100-m of FIG. 1B. Device 100-o may include one or more radiators 120-o. One or more thermally-conductive, bendable hinges 130-o may couple the one or more radiators 120-o with one of more heat sources 140-o. The one or more thermally-conductive, bendable hinges 130-o may form living hinges. One or more thermal switches 150 may be positioned to control the flow of heat from the one or more heat sources 140-o to the one or more radiators 120-o. The one or more thermal switches 150 may be positioned either before or after the one or more thermally-conductive, bendable hinges 130-o.

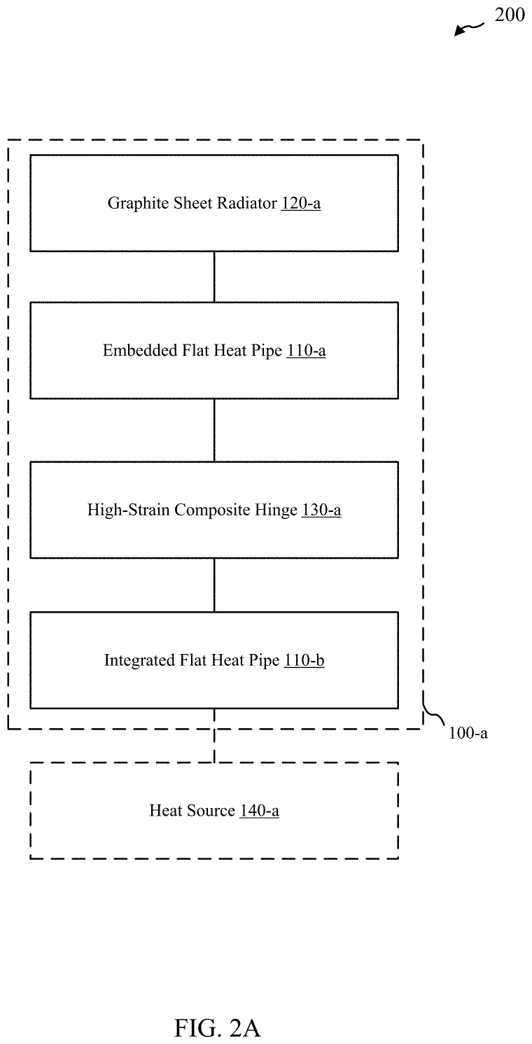

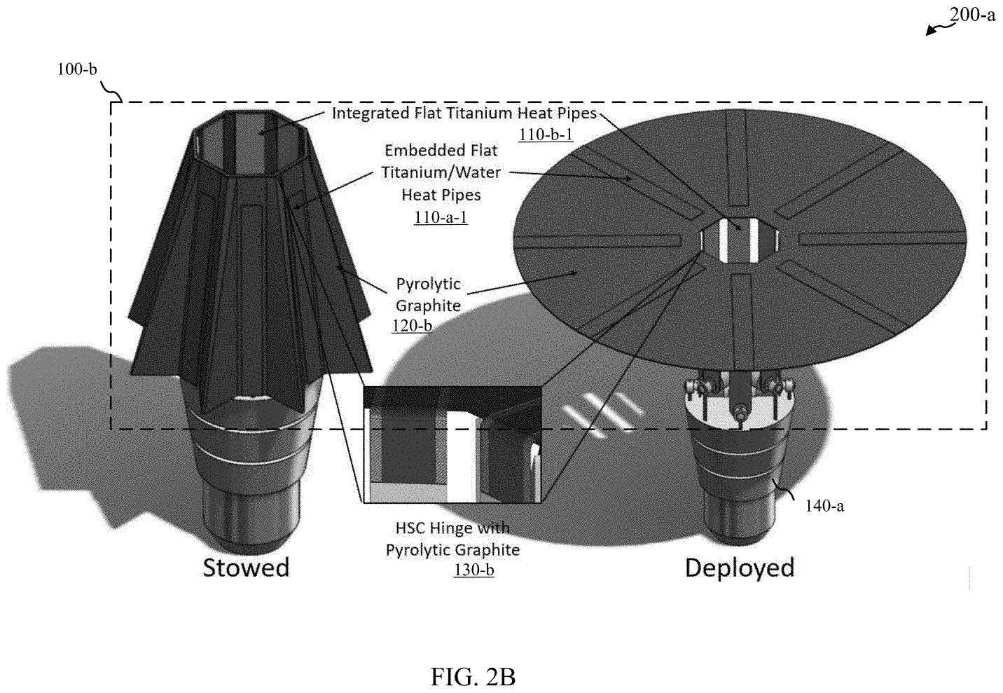

Turning now to FIG. 2A, a system 200 in accordance with various embodiments is provided. System 200 may include a passively deployable radiator device 100-a, which may be an example of device 100 of FIG. 1A, device 100-m of FIG. 1B, device 100-n of FIG. 1C, and/or device 100-o of FIG. 1D. System 200 may be an example of system 101 of FIG. 1A, system 101-m of FIG. 1B, and/or system 101-n of FIG. 1C. System 200 may include a heat source 140-a that the device 100-a may be thermally coupled with. Device 100-a may include a radiator 120-a formed from graphite sheets, such as pyrolytic graphite. Embedded between the graphite sheets may be one or more flat heat pipes 110-a. In some embodiments, the flat heat pipes 110-a may be formed from titanium and charged with water. In some embodiments, the radiator 120-a may form a composite overwrap pressure vessel for the flat heat pipe 110-a. The radiator 120-a may form a flexible structure.

The one or more embedded flat heat pipes 110-a may each be coupled with a high-strain composite hinge 130-a, which in turn may be coupled with another integrated flat heat pipe 110-b. The high-strain composite hinge 130-a may be referred to as a thermally-conductive, bendable hinge. The thermally-conductive, bendable hinge 130-a may form living hinges. The integrated flat heat pipe 110-b may be configured to couple with the heat source 140-a, such as a Stirling engine, though other heat sources may be utilized. In some embodiments, the integrated flat heat pipe(s) 110-b may be formed from titanium and charged with water. The integrated flat heat pipe(s) 110-b may include through holes to facilitate coupling with the heat source 140-a.

FIG. 2B shows a stowed and deployed state for a system 200-a in accordance with various embodiments. System 200-a may be an example of system 200 of FIG. 2A. System 200-a may include a passively deployable radiator device 100-b shown in the stowed and deployed state. Device 100-b may be an example of device 100 of FIG. 1, device 100-m of FIG. 1B, device 100-n of FIG. 1C, device 100-o of FIG. 1D.and/or device 100-a of FIG. 2A. Device 100-b may include multiple flat heat pipes 110-a-1 that may be coupled with a radiator 120-b, which may include multiple pyrolytic graphite layers for example; in some embodiments, the flat heat pipes 110-a-1, which may be referred to as integrated flat heat pipes, may include a titanium/water heat pipe that may be embedded within the radiator 120-b. The flat heat pipes 110-a-1 may provide isothermal, high conductivity element embedded in the deployed surface of the radiator 120-b for improved fin efficiency. Some embodiments may improve radiator fin efficiency in the flexible portion of the radiator using materials such a pyrolytic graphite sheet composite laminate. Some embodiments provide a solid-state high-strain composite hinge 130-b to deploy and support the radiator 120-b with elastic strain energy and a thermal path across the hinge line with a thermally conductive material, such as pyrolytic graphite. Hinge 130-b may be referred to as thermally conductive, bendable hinge. Additional flat heat pipes 110-b-1 may be thermally coupled with a heat source 140-a, such as a Stirling engine for example; flat heat pipes 110-b-1 may be referred to as integrated flat heat pipes.

Merely by way of example, system 200-a may enable the use of kilowatt class Fission Power Systems for surface missions to the moon and Mars. In some embodiments, system 200-s is capable of dissipating 2 kW of thermal energy per 1 kWe of output.

System 200-a may provide benefits over existing systems. For example, round heat pipes are typically bent to interface with a heat source on one end and may be interfaced with a radiative surface on the other end. Graphite foam saddles may be used to handle the CTE mismatch between the heat pipe and radiator. The use of these saddles and the round heat pipe interface may increase thermal resistance along the heat removal path, which in turn may lead to reduced efficiency in fission power systems. Systems in accordance with various embodiments that may include a flat heat pipe and flexible radiator blanket may address these problems.

For example, thin, flat heat pipes 110-b-1 in accordance with various embodiments can interface to the heat source, such as a Stirling engine's flat surface, with low thermal resistance, which may provide improved radiator fin efficiency, and may be simple to bend. The flat heat pipe 110-a-1 may also be coupled with highly conductive (k>1,000 W/m-K) flexible blanket materials that may include laminate pyrolytic graphite, stainless steel, and radiator surface coatings such as Ag-coated Teflon. In addition, some embodiments may utilize the high-strain composite (HSC) hinge(s) 130-b that may provide a lightweight and compact deployment mechanism for the radiator that can be coupled with radiator material, such as pyrolytic graphite, to maintain a highly conductive thermal path across the hinge.

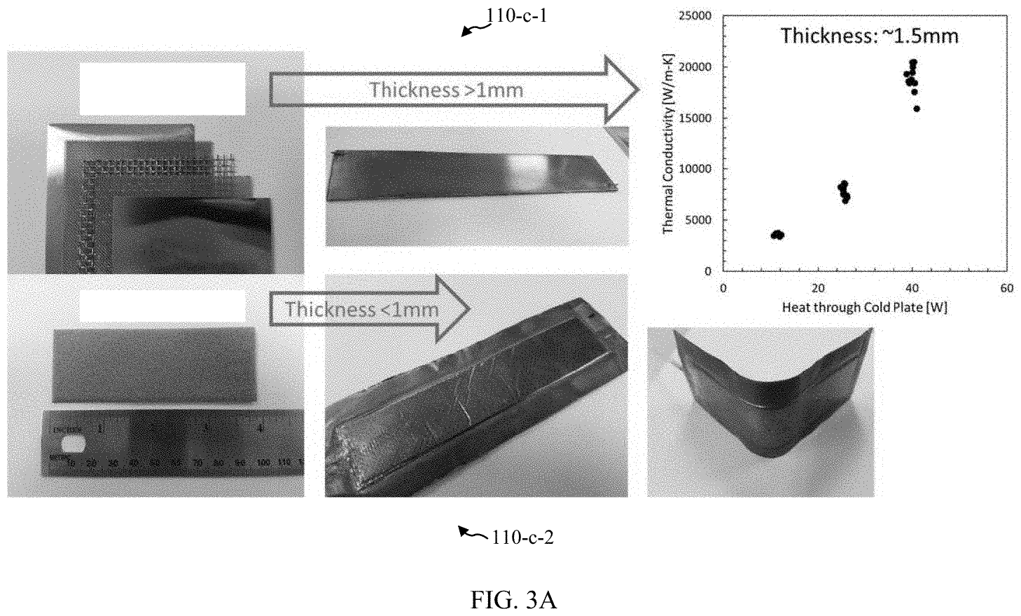

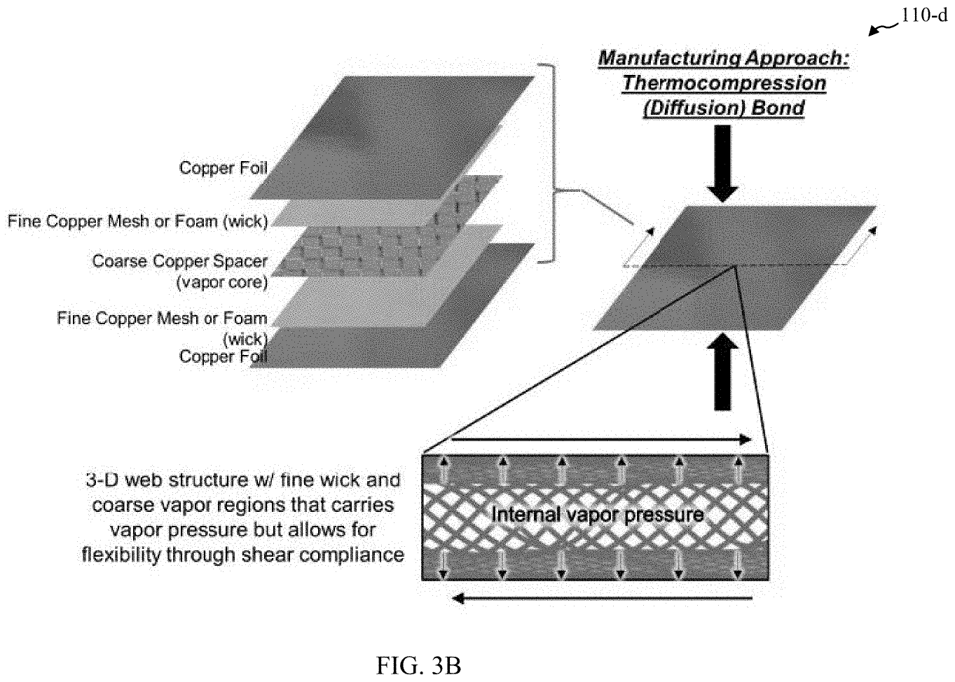

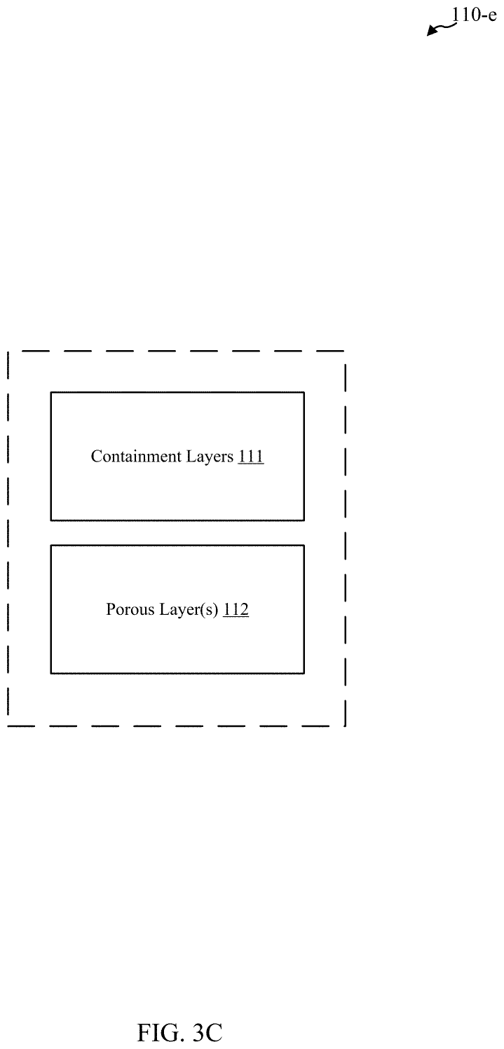

Turning now to FIG. 3A, aspects of several flat heat pipes 110-c-1, 110-c-2 are provided in accordance with various embodiments. Heat pipes 110-c-1, 110-c-2 may be examples of flat heat pipe 110 of FIG. 1, heat pipe 110-m of FIG. 1B, heat pipe 110-n of FIG. 1C, heat pipe 110-o of FIG. 1D, heat pipes 110-a/110-b of FIG. 2A, and/or heat pipes 110-a-1/110-b-1 of FIG. 2B. While heat pipes generally provide an efficient lightweight heat transport solution, aspects of their geometry and stiffness may limit their ease of system integration and packaging efficiency. Thin flexible two-phase thermal transport devices in accordance with various embodiments may overcome the shortcomings of conventional heat pipes in spacecraft applications.

By constructing a heat pipe from layers of films, foils, meshes, and/or screens, thin flat heat pipes may be formed in accordance with various embodiments. Such heat pipes may have a wide variety of applications, including, but not limited to commercial, terrestrial, planetary, military, and/or spacecraft applications.

Some embodiments may include heat pipes that are focused on increasing the thermal performance of thin flat heat pipes for use in high energy lasers as well as in spacecraft applications. Some embodiments may optimize a set of materials for thin heat pipe construction. For instance, copper foams may be found to wet with more liquid and evaporate liquid faster than woven meshes due to the more random and consistent capillary voids in their microstructure. Viscous flow resistance in the vapor core, traditionally ignored in heat pipes as negligible, may actually be a key performance parameter in thin heat pipes that may involve significant consideration. Some embodiments with more open vapor cores may show some of the highest performance in thin heat pipes.

Design parameters such as thickness, porosity, mechanical strength, etc. may be tailored to optimize flat heat pipes in accordance with various embodiments for bendability vs. thermal performance vs. durability. While FIG. 3A may show flat heat pipes that may utilize copper as one or more layers (e.g., containment, wick, vapor core), some embodiments may utilize titanium or other materials. The dimensions provided are merely for example purposes. Heat pipe 110-c-1 may generally be thicker than heat pipe 110-c-2.

FIG. 3B shows a flat heat pipe 110-d along with exploded view in accordance with various embodiments. Heat pipe 110-d may be examples of flat heat pipe 110 of FIG. 1, heat pipe 110-m of FIG. 1B, heat pipe 110-n of FIG. 1C, heat pipe 110-o of FIG. 1D, heat pipes 110-a/110-b of FIG. 2A, heat pipes 110-a-1/110-b-1 of FIG. 2B, and/or heat pipe 110-c of FIG. 3A. Some embodiments may include innovative manufacturing approaches and processes with diffusion bonded interfaces. Typical manufacturing techniques for heat pipe construction may have utilized processes familiar to the microelectronics industry, such as photolithography and chemical etching of microchannels, to industrial process such as roll forming stamping and TIG welding. In contrast, some embodiments may utilize manufacturing processes that may allow for homogeneous layered materials without contact thermal resistances. Thermocompression, or diffusion bonding, may include a process that applies a high compression and temperature to stacked assemblies in a vacuum furnace. The elevated temperature and intimate atomic contact at interfaces may allow for the migration and diffusion of grains in crystalline materials to grow together, which may create a single homogeneous hybrid microstructure without contact thermal resistance between different layers of the heat pipe. Additionally, the mechanical strength through the thickness of different flat heat pipes in accordance with various embodiments may be so robust that some of the flat heat pipe parts have been pressure tested to more than 135 psi with no out-of-plane distortion. While FIG. 3B may show flat heat pipe construction that may utilize copper as one or more layers (e.g., containment, wick, vapor core), some embodiments may utilize titanium or other materials.

FIG. 3C shows a general two-phase thermal management devices 110-e in accordance with various embodiments that may be an example of flat heat pipe 110 from FIGS. 1A, FIG. 1B, FIG. 1C, FIG. 1D, FIG. 2A, FIG. 2B, FIG. 3A, and/or FIG. 3B. Device 110-e may have two or more containment layers 111 and one or more porous layers 112. The two or more containment layers 111 and one or more porous layers 112 may be bonded with each other to form an uninterrupted stack of material layers.

The two or more containment layers 111 and one or more porous layers 112 may be bonded with each other such that a first side of each respective porous layer from the one or more porous layers 112 and a second side of each respective porous layer from the one or more porous layers 112 may each be respectively bonded with at least a side of one of the two or more containment layers 111 or a side of one of the other one or more porous layers 112.

In some embodiments of device 110-e, the two or more containment layers 111 and the one or more porous layers 112 are bonded with each other such that a first side of a first containment layer from the two or more containment layers 111 is bonded with a first side of a first porous layer from the one or more porous layers 112. A first side of a second containment layer from the two or more containment layers 111 may be bonded with at least a second side of the first porous layer or a first side of a second porous layer from the one or more porous layers 112. A second side of the second porous layer may be bonded with at least the second side of the first porous layer or one or more additional porous layers from the one or more porous layers 112 such that at least one of the additional porous layers may be bonded with the second side of the first porous layer.

In some embodiments of device 110-e, the two or more containment layers 111 and the one or more porous layers 112 are diffusion bonded with each other. Some embodiments of device 110-e include a working fluid disposed between the two or more containment layers 111. The working fluid may include at least ammonia, acetone, methanol, water, or ethyl alcohol. The working fluid may include a variety of refrigerants in general. In some embodiments, the working fluid may include different cryogenic liquids, such as liquid nitrogen, liquid helium, or liquid hydrogen, for example. Some embodiments may utilize working fluids suitable for high temperature applications, such as liquid sodium or other liquid metals. In some embodiments, the working fluid includes paraffin.

In some embodiments of device 110-e, the two or more containment layers 111 and the one or more porous layers 112 are made from one or more flexible materials. For example, one or more porous layers 112 may include at least a first liquid wicking layer and a vapor layer positioned between the first liquid wicking layer and at least one of the two or more containment layers 111. In some embodiments, the one or more porous layers 112 includes a second liquid wicking layer positioned such that the vapor layer is positioned between the first liquid wicking layer and the second liquid wicking layer. In some embodiments of device 110-e, the first liquid wicking layer includes a first copper mesh, the second liquid wicking layer includes a second copper mesh, and the vapor layer includes at least a third copper mesh or a copper foam; the third mesh may include fewer wires per unit length than the first mesh or the second mesh. In some embodiments of device 110-e, the two or more containment layers 111 include a first copper foil and a second copper foil. In some embodiments of device 110-e, the two or more containment layers 111 include at least a copper foil, an aluminum foil, a stainless-steel foil, or a titanium foil. In some embodiments, the porous layers 112 include titanium. Some embodiments may be fabricated such that the wicking layer and the vapor layer are included in the same layer of device 110-e.

In some embodiments of device 110-e, the two or more containment layers 111 include a first containment layer, a second containment layer, and a third containment layer. The one or more porous layers 112 may include at least a first porous layer positioned between at least a portion of the first containment layer and a portion of the second containment layer and at least a second porous layer positioned between at least a portion of the second containment layer and at least a portion of the third containment layer. The first containment layer, the second containment layer, and the third containment layer may be stacked with respect to each other perpendicularly to a main plane in some embodiments. The first containment layer and the third containment layer may be skewed with respect to each other in some embodiments.

In some embodiments, the one or more porous layers 112 include a first mesh layer, a second mesh layer, a third mesh layer, and a fourth mesh layer. The first mesh layer and the third mesh layer may include fewer wires per unit length than the second mesh layer and the fourth mesh layer. In some embodiments, at least a portion of the first mesh layer is positioned between the second mesh layer and a first containment layer from the two or more containment layers 111. In some embodiments, at least a portion of the third mesh layer is positioned between the fourth mesh layer and a second containment layer from the two or more containment layers 111. Some embodiments may further include a fifth mesh layer positioned between the second mesh layer and the fourth mesh layer; the fifth mesh layer may include fewer wires per unit length than the first mesh layer, the second mesh layer, the third mesh layer, and the fourth mesh layer. Some embodiments may include a window aperture positioned between the two or more containment layers 111.

In some embodiments, device 110-e is configured for space applications; other general applications may include aerial vehicles, planetary or lunar exploration, and/or terrestrial devices. In some embodiments, device 110-e is configured to maintain its shape when exposed to an internal pressure greater than an external pressure. In some embodiments, device 110-e is configured to carry an internal vapor pressure of the working fluid greater than an external pressure. In some embodiments, the device is configured with one or more evaporator regions and one or more condenser regions.

In some embodiments, device 110-e is configured to passively move the working fluid located between the two or more containment layers. In some embodiments, another portion of a first containment layer from the two or more containment layers 111 and another portion of a second containment layer of the two or more containment layers 111 are bonded with each other to form one or more seals for the device. In some embodiments, the one or more porous layers include at least two porous layers that partially overlap.

Some embodiments of device 110-e include a first working fluid and a second working fluid, where the device is configured to passively move the first working fluid located between a first containment layer from the two or more containment layers 111 and a second containment layer from the two or more containment layers 111. Device 110-e may be configured to actively move the second working fluid located between the second containment layer and a third containment layer from the two or more containment layers 111.

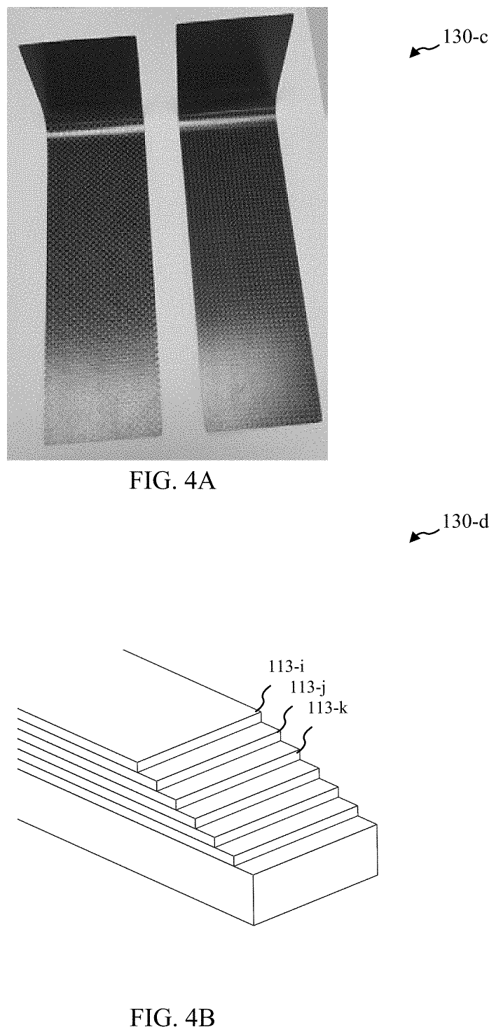

Turning now to FIG. 4A and FIG. 4B, examples of strain energy components 130-c and 130-d are provided in accordance with various embodiments. Strain energy components 130-c and 130-d may be examples of strain energy components hinges 130 of FIG. 1A, 130-m of FIG. 1B, 130-n-1/130-n-2 of FIG. 1C, 130-o of FIG. 1D, 130-a of FIG. 2A, and/or 130-b of FIG. 2B. Strain energy components 130-c and 130-d may provide examples of high-strain composite (HSC) hinges. HSC hinges in accordance with various embodiments may facilitate deployment and support of passively deployable radiator devices such as those provided in FIG. 1A, FIG. 1B, FIG. 1C, FIG. 1D, FIG. 2A, and/or FIG. 2B. Strain energy components 130-c and/or 130-d may be referred to as thermally conductive, bendable hinges. Strain energy components 130-c and/or 130-d may be examples of living hinges. In some embodiments, the HSC hinges may have an elastic strain capability that may enable bending or flattening of the structural members to stow and completely passive deployment with the stored strain energy. The extraordinarily simple and extremely efficient solid-state material approach may allow for extremely compact deployable radiators in a variety of different applications. In some embodiments, the HSC hinge may include pyrolytic graphite that may help conduct heat between different elements of the passively deployable radiator device, such as between two flat heat pipes.

Device 130-d may provide an example of a high-strain composite hinge in accordance with various embodiments that may be configured as an asymmetric composite laminate, which may change shape with a temperature change. The asymmetric composite laminate may have anisotropic layers, such as layers 113-i, 113-j, 113-k. Device 130-e may address passive variable heat rejection issues through the use of a thermally activated, fiber composite structures that provide temperature-dependent deflection. Anisotropic carbon fiber composite layup through layers (e.g., 113-i, 113-j, 113-k) such as that may result in a CTE mismatch between inner and outer surfaces of the support structure. Applying heat to the device 130-e, configured as a hinge for example, may result in deflection of the devices, such as radiator 120 and/or flat heat pipe 110 of FIG. 1 for example, through a variety of deflection angles.

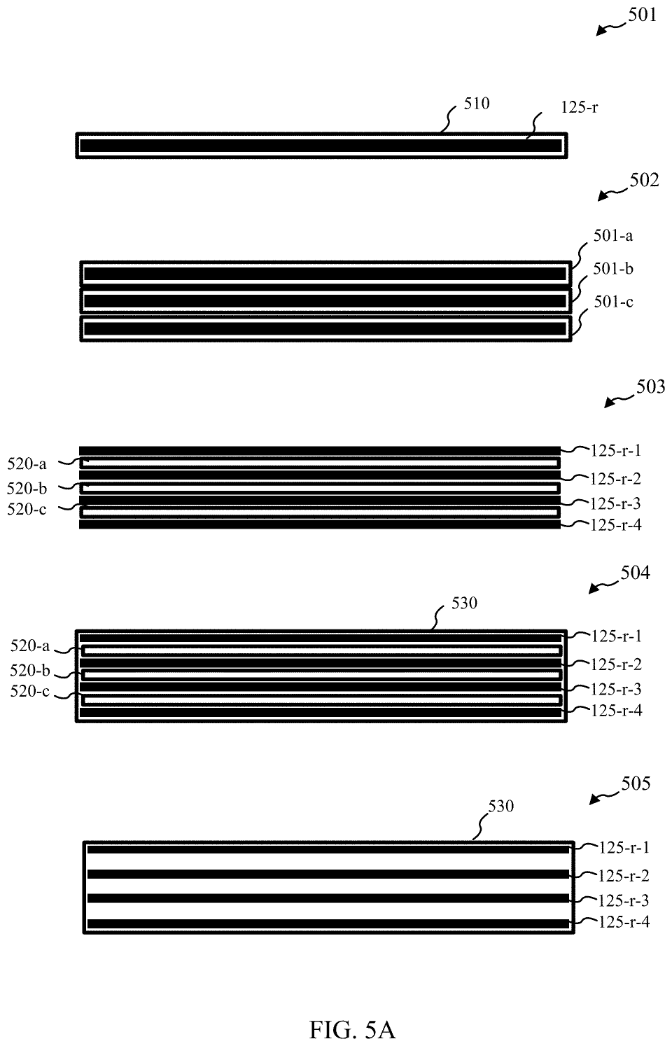

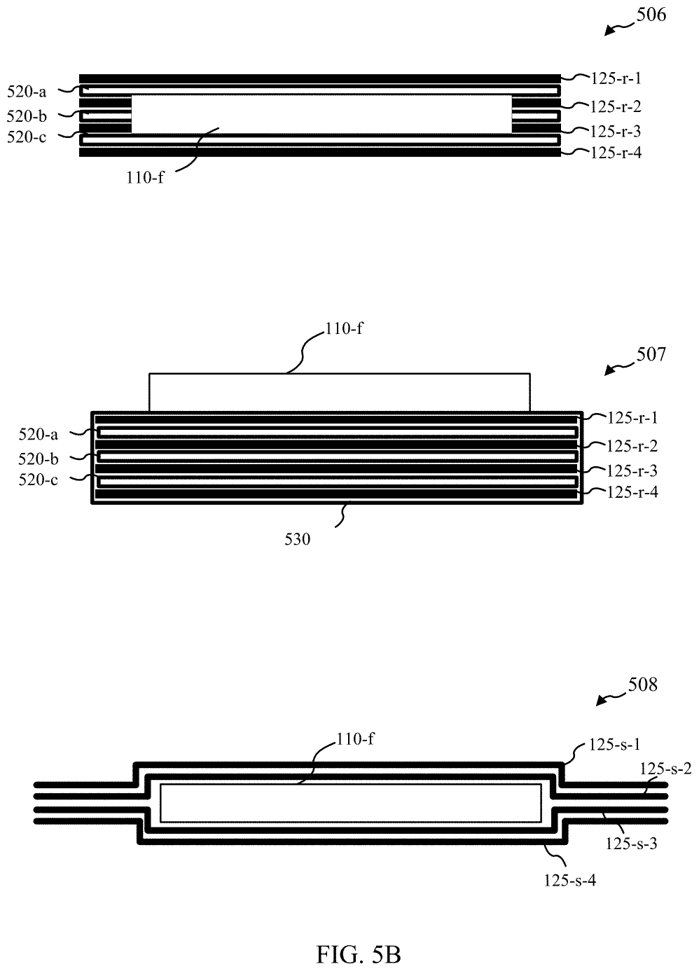

Turning now to FIG. 5A, a variety of configurations of thermally conductive layers for passively deployable radiator devices are provided in accordance with various embodiments. These configurations may generally show the use of encapsulants, envelopes, adhesives, or other bonding elements, and/or coatings in accordance with various embodiments. These configurations may be generally applicable to the radiators 120 with thermally conductive layers (e.g. layers 125) of FIG. 1A, FIG. 1B, FIG. 1C, FIG. 1D, FIG. 2A, and/or FIG. 2B.

Since temperature uniformity may play a dominant role in efficient heat dissipation of the different passively deployable radiators in accordance with various embodiments, the deployable radiators may be designed with material that may be both flexible and highly conductive. The use of graphite and/or graphene sheets, such as pyrolytic graphite sheet (PGS), may provide highly conductive layer in the panel construction. A variety of PGS thicknesses may be utilized, including but not limited to 0.001″ and 0.004″ thick PGS. Though PGS is generally available in thinner and higher conductivity options, these options generally include an acrylic PSA (pressure sensitive adhesive) backing that is available in thicknesses as small as 10 ηm. For 0.001″ thick PGS the in-plane thermal conductivity may be 1,600 W/m-K which may be 4× higher than copper.

One of the challenges with PGS may include its fragility and/or susceptibility to environmental degradation. In some embodiments, an encapsulant may be utilized that may help address this challenge. For example, FIG. 5 shows an example 501 of a polymer encapsulant 510 that may encapsulate and support a PGS 125-r. There are several factors that may be considered, including ease of processing, cost, and/or impact on thermal conductivity. In some embodiments, the volume fraction of high thermal conductivity PGS may be maximized, which may mean that the thickness of the encapsulant as well as any adhesive used to bond the sheets together may be minimized.

Merely by way of example some PGS layers may have a 1 mil thickness, though other thicknesses may be utilized. An example thermal conductivity of PGS layer may be 1600 W/mk, though other conductivities may be found. Some PGS layers may be rated from over 3000 bending cycles at a 2 mm radius. Some PGS layers may be delicate with low tear resistance; some embodiments may utilize bonding techniques to address this issue. Some embodiments may utilize off-the-shelf PGS layers, for example, with 4.5 in×7 in dimensions, though other dimensions may be utilized.

Some encapsulation methods include applying an extremely thin and uniform encapsulating layer to each PGS sheet using a dip coating process. To achieve this, the encapsulating polymer, which may include an epoxy or polyurethane (which may be selected based on environmental and structural requirements, for example), may be diluted in a solvent (i.e. acetone) to create a low viscosity varnish. The PGS sheet may then be dipped into the varnish, after which it may be placed in an oven to flash off the solvent and cure the encapsulant. The thickness of the coating may be tailored based on the amount of solvent used in the varnish. Using this method, a uniform coating thickness as thin as 6 microns may be achieved. The resulting encapsulated PGS sheets may have improved handle-ability and environmental robustness.

Example 502 shows an embodiment where individual encapsulated sheets 501-a, 501-b, 501-c may be stacked and a low viscosity adhesive may be used to bond them together, which may result in a panel configuration. In some embodiments, different portions of the stacked sheets may be bonded, such as with respect to a rigid hub and/or rigid radiator. In some embodiments, different portions of the stacked sheets may not be bonded with each other, such as with respect to a flexible layered radiator.

Example 503 provides another an encapsulation (or bonding) method that may include assembling the radiator panel using adhesive and/or bonding components. Example 503 may show multiple PGS layers 125-r-1, 125-r-2, 125-r-3, 125-r-4 and bonding layers 520-a, 520-b, 520-c; while four PGSs layers and three bonding layers may be shown, other embodiments may utilize more or fewer layers.

Some embodiments may utilize an adhesive, such as a Pressure Sensitive Adhesive (PSA) as the bonding layers 520-a, 520-b, 520-c. Acrylic-based PSAs may be made as thin as 6 microns, for example, and some formulations may have excellent environmental resistance. The PSA may function as an encapsulant, while also bonding the individual sheets together to form the panel structure. Some embodiments may utilize other forms of bonding layers 520, such as the use of diffusion bonding with the use of metal foils or meshes as bonding layers 520-a, 520-b, 520-c disposed between the PGS layers 125-r-1, 125-r-2, 125-r-3, 125-r-4. For example, stainless steel foils and/or stainless steel meshes may be utilized; in some embodiments, 304 stainless steel foils and 316 stainless steel mesh 500 (woven screen) may be utilized; other metals and sizes may be utilized.

The interstitial layers of stainless steel 520-a, 520-b, 520-c that bond each of the PGS layers 125-r-1, 125-r-2, 125-r-3, 125-r-4 together may have thermal conductivity 20 times greater than that of some acrylic adhesive. In addition, the bonded joint may be compact and flat, which may create a uniformly thick composite radiator panel. These foils may also be found in thicknesses as low as 0.0005″, so very thin layups can be realized. By applying a diffusion bonding process, the contact resistance between PGS layers 125-r-1, 125-r-2, 125-r-3, 125-r-4 and stainless-steel sheets 520-a, 520-b, 520-c may be minimized.

Some embodiments may result in a reduced amount of complexity compared to state-of-the-art passive deployable radiator and may allow for direct attachment to components, which may eliminate inherent extra contact resistance introduced in current state-of-the-art devices.

Some embodiments may provide further encapsulation or enveloping for the multiple PGS layers that may be bonded together. For example, to environmentally protect the outside surfaces of the panel, such as panel 503, a thin (e.g., quarter mil thick) layer of

Kapton film may be applied to the surfaces of the panel using the PSA or the adhesives in some. Example 504 may show such an example that includes an outer layer 530.

In some embodiments, outer layer 530 may also include one or more coatings; the coatings may act as an envelope or encapsulant in some embodiments. For example, one or more coatings may be applied to one or more surfaces of the one or more the PGS layers 125-r-1, 125-r-2, 125-r-3, 125-r-4. The one or more coatings may include at least a high emissivity coating or a low absorption coating, for example. In some embodiments, the coating(s) may include a silver(Ag)-coated Teflon, though other space-rated materials with high emissivity and/or low absorptivity may be utilized. Some embodiments may apply a coating of black paint to the PGS layers, which may be applicable for when the PGS layers may be utilized for a radiation-based design, in contrast to a conduction-based design. For a radiation-based design, an adhesive or other bonding element may not be placed between the PGS layers in some embodiments (example 505 provides such an example), whereas conduction-based designs (for e.g., examples 501, 502, 503, and/or 504) may generally bond the PGS layers with each other. One may note that increasing the number of PGS layers may generally result in a larger conductive cross-sectional area, which may result in a decrease in the total thermal resistance along the length of a panel.

Some embodiments may be configured to control turndown ratio with respect to outer layer 530. For example, an aluminized Kapton film as an outer surface coating and/or a black paint coating on the inner surfaces may be utilized in some embodiments.

With respect to examples 501, 502, 503, 504, and 505, some embodiments further include one or more flat heat pipes 110 (not shown in FIG. 5A) that may be embedded between two or more layers 125 or coupled with an exterior layer 125 or outer layer 530. FIG. 5B provides several examples of different configurations in accordance with various embodiment. For example, example 506 shows example 503 with a flat heat pipe 110-f embedded between PGS layers 125-r of the radiator. Heat pipe 110-f may be an example of pipe 110 of FIG. 1A, FIG. 1B, FIG. 1C, FIG. 1D, FIG. 2A, FIG. 2B, FIG. 3A, FIG. 3B, and/or FIG. 3C. These configurations may be generally applicable to the radiators 120 with thermally conductive layers (e.g. layers 125) of FIG. 1A, FIG. 1B, FIG. 1C, FIG. 1D, FIG. 2A, and/or FIG. 2B. Example 507 shows example 504 with flat heat pipe 110-f coupled with an exterior layer. Example 508 shows an example where the PGS layers 125-s-1, 125-s-2, 125-s-3, and 125-s-4 may conform around the flat heat pipe 110-f; some embodiments may include bonding layers, encapsulation, and/or outer coating layers as discussed with respect to the other examples. In some embodiments, the PGS layers and/or bonding layers form a composite overwrap pressure bearing vessel with respect to the flat heat pipe 110-f. The relationship between the flat heat pipe 110-f and the PGS layers 125 may not be to scale; the width of the PGS layers 125, for example, may be exaggerated. Furthermore, while layers 125 may generally be referred to as PGS layers, layers 125 may generally refer to thermally conductive layers, which may include but are not limited to carbon layers. As noted, some embodiments include layers 125 that include graphite and/or graphene layers.

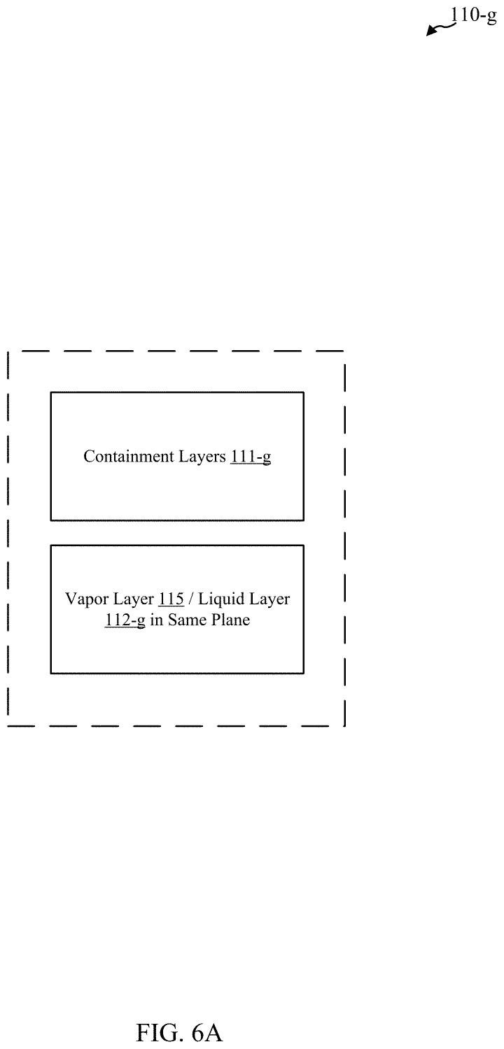

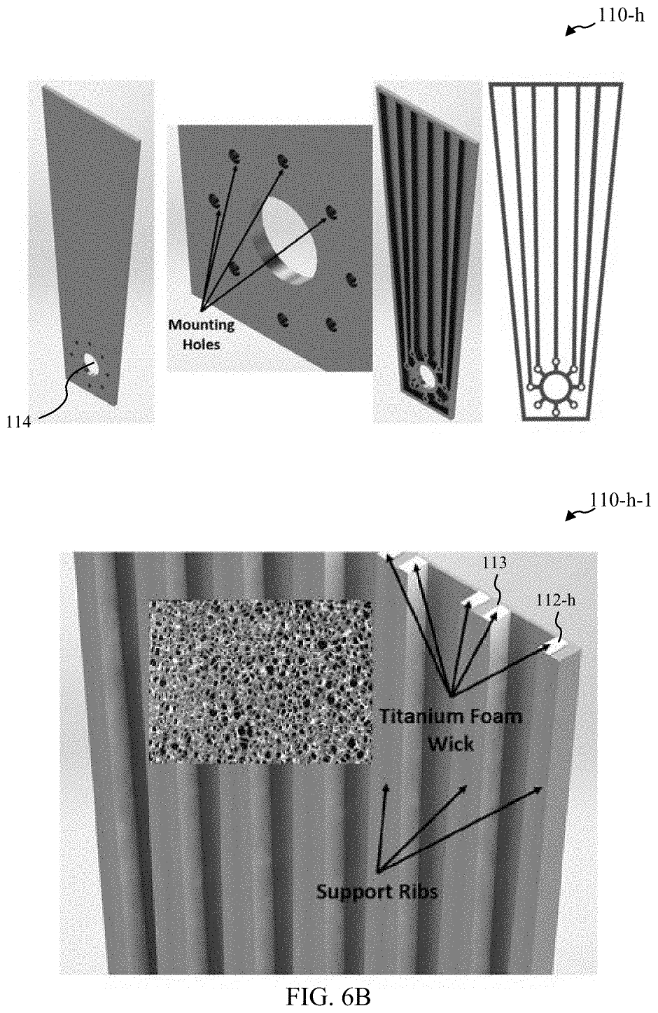

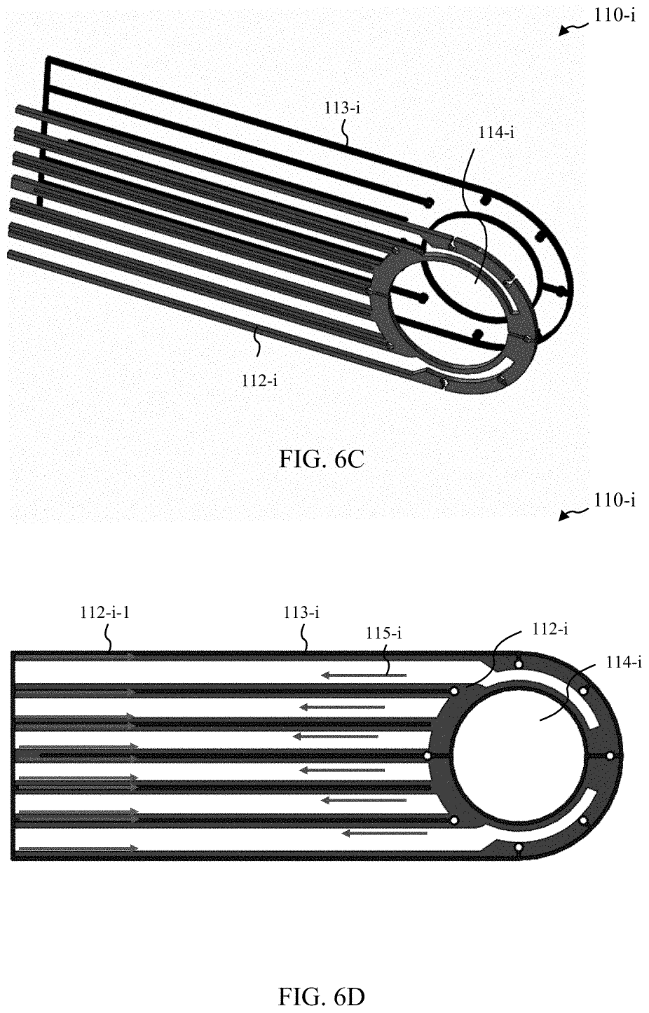

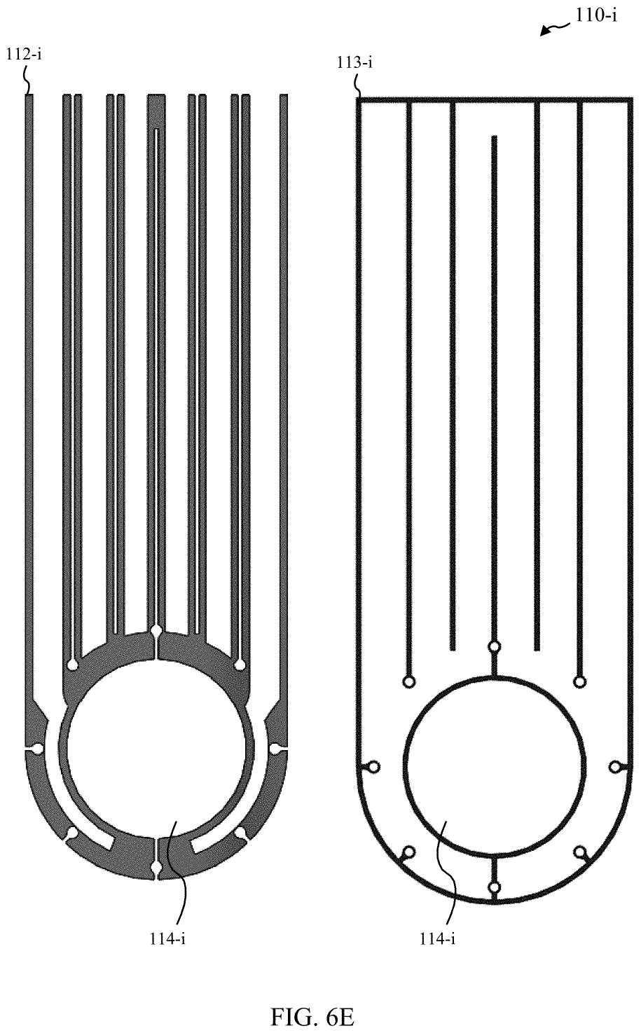

Turning now to FIG. 6A, a heat pipe device 110-g in accordance with various embodiments is provided. Device 110-g may be an example of device 100 of FIG. 1A, FIG. 1B, FIG. 1C, FIG. 1D, FIG. 2A, FIG. 2B, FIG. 3A, FIG. 3B, FIG. 3C, and/or FIG. 5B. The device 110-g may include multiple containment layers 111-g, such as a first containment layers and a second containment layer. The device 110-g may include a vapor layer 115 formed between the first containment layer and the second containment layer. The device 110-g may include a liquid layer 112-g formed between the first containment layer and the second containment layer. The vapor layer 115 and the liquid layer 112- may be within a same plane of the heat pipe device 110-g. The heat pipe device 110-g may be configured as a flat heat pipe.

Some embodiments of device 100-g include one or more slotted wicks that may form part of the liquid layer 112-g. Some embodiments include one or more slotted ribs; the one or more slotted ribs may support one or more of the slotted wicks. The one or more slotted wicks may include a titanium foam. Some embodiments include one or more through holes configured to couple the heat pipe device with one or more heat sources.

Turning now to FIG. 6B, aspects of a flat heat pipe 110-h in accordance are provided in accordance with various embodiments, which may be an example of aspects of flat heat pipe 110 of FIG. 1B, FIG. 1C, FIG. 2A, FIG. 2B, FIG. 3A, FIG. 3B, FIG. 3C, FIG. 5B; in particular, heat pipe 110-h may be an example of heat pipe 110-g of FIG. 6A. The device 110-h may include a passthrough or through hole 114 that may interface directly with a heat source, such as the cold side of the Stirling engine, and may have a bolted or bonded connection (mounting holes may be shown in particular). Device 110-h may show a fin, which may be fabricated from titanium, with integrated mounting holes with an internal water jet cut frame. The device 110-h may include walls with hybrid wicks and an internal rib structure that may provide the vapor core of the heat pipe. In some embodiments, the device 110-h may extend upward where the top may interface with the deployable radiator material (see, e.g., FIG. 2B), which may include being coupled with a strain energy component, such as an HSC hinge. Another flat heat pipe in accordance with various embodiments may be embedded in the radiator itself to increase fin efficiency. The thermal path may be repeated around the circumference of the heat source, such as a power generator, with one flat heat pipe interface for every Stirling engine, for example.

Some embodiments may utilize titanium as the material for the fin structure because it generally is well suited for many heat pipe applications. It generally has a high strength to-weight ratio, high fracture toughness, corrosive resistant in harsh conditions, and is highly compatible with water. Additionally, titanium can be readily welded and hermetically sealed. Titanium/water heat pipes may be able to withstand gamma radiation.

FIG. 6B also shows aspects of flat heat pipe 110-h-1 in accordance with various embodiments, which may be an example of aspects of flat heat pipe 110-h. For example, a unique feature of some heat pipes in accordance with various embodiments utilize commercially available titanium foam, as a slotted foam wick 112-h, for the capillary wick structure that may be supported by a slotted frame, as shown in FIG. 6B. By utilizing an in-plane wick, the heat pipe can be optimized for thickness. The device may include in-plane surface treated foam wick surrounding support ribs 113. To manufacture the two-phase fin, a frame may be water jetted, as may be the titanium foam; the foam and the frame may then be diffusion bonded to produce a hermetic seal. The performance of the fin may be further enhanced by applying an ultra-hydrophilic surface treatment that may lead to an increase in wicking velocity. A variety off surface treatments may be utilized along with different materials besides titanium, including, but not limited to copper.

An important consideration for the titanium heat pipe fin in accordance with various embodiments may be the ability to withstand excessive internal pressure due to elevated temperatures. A work to analyze the stresses at a saturation temperature of 250° C. may show an internal pressure approaches 40 atm, suggesting that even under this high pressure the fin remains below the yield strength.

FIG. 6C and FIG. 6D provide aspects of a heat pipe 110-i construction in accordance with various embodiments, which may be examples of aspects of heat pipes 110 of FIG. 1B, FIG. 1C, FIG. 2A, FIG. 2B, FIG. 3A, FIG. 3B, FIG. 3C, FIG. 5B, FIG. 6A, and/or FIG. 6B. In generally, these include a passthrough/through hole 114-i along with a support rib structure 113-i (which may be referred to as a slotted frame) and wicking structure 112-i (which may be referred to as a slotted foam wick). FIG. 6D may also show the in-plane flows, with vapor flows 115-i shown with the left-directed arrows and liquid flows 112-i-1 shown with the right-directed arrows. FIG. 6E shows additional perspectives on these components.

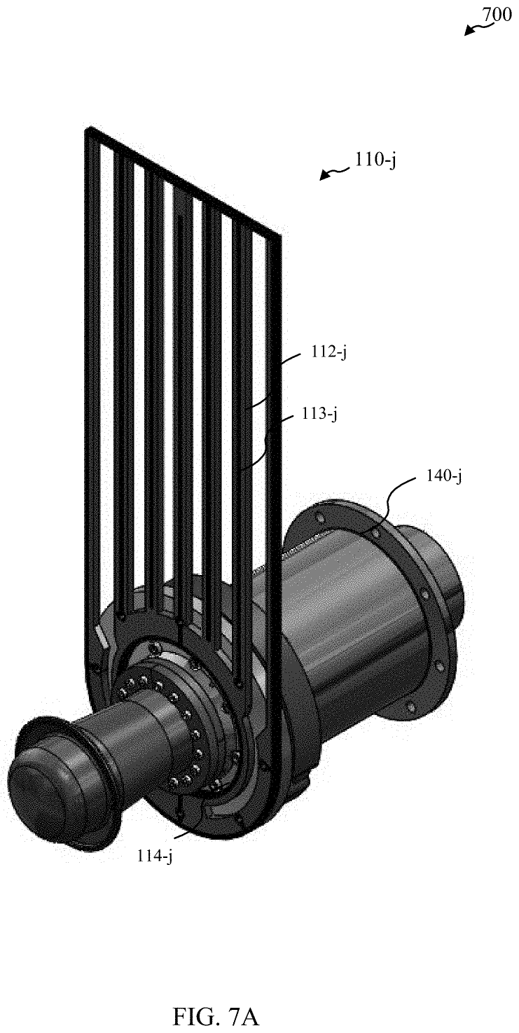

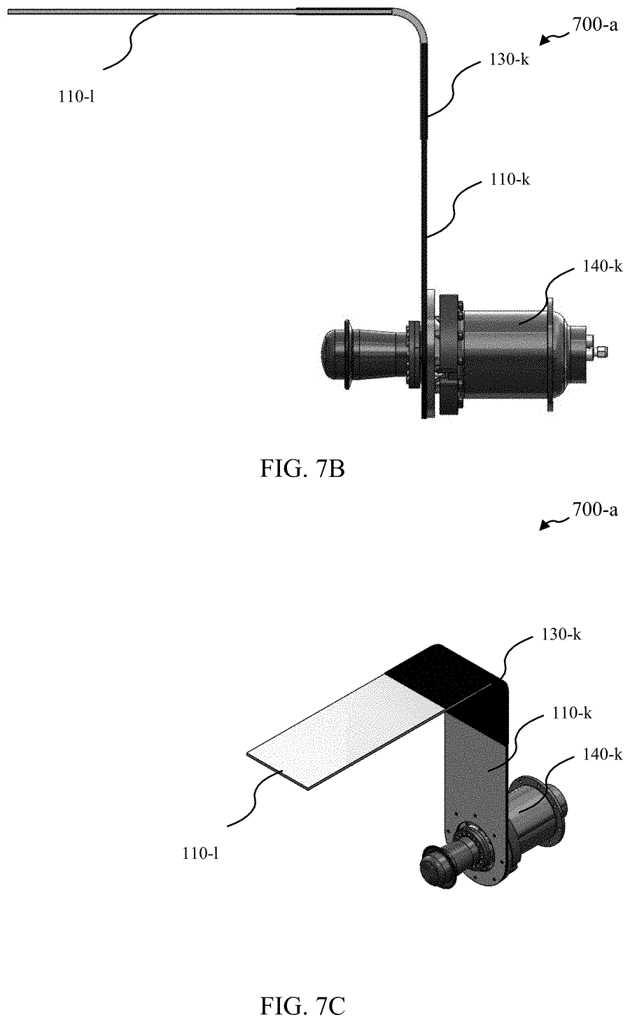

FIG. 7A provide examples of how a flat heat pipe 110-j may be coupled with a heat source 140-j (which may include components between the pipe 110-j and the heat source 140-j). Heat pipe 110-j may be an example of heat pipe 110-i of FIG. 6C-6E. FIG. 7A shows aspects of a system 700 that may reflect the wicking structure 112-j and support rib 113-j of the flat heat pipe 110-j (the containment layers of the heat pipe are not shown) in particle, with a through hole 114-j such that the flat heat pipe 110-j may be coupled with the heat source 140-j. FIG. 7B and FIG. 7C show two perspective on a system 700-a with a first flat heat pipe 110-k coupled with a heat source 140-k via a through hole along with additional flat heat pipe 110-l that may be embedded in a radiator (not shown) along with a strain energy component, such as an HSC hinge 130-k, which may facilitate passive deployment along with thermal conduction. FIG. 7D shows system 700-b that provides a variation of

FIG. 7B and 7C where a foldable strut 130-k may provide for support after deployment; in some cases, the strut may also facilitate deployment through providing strain energy; the foldable strut 130-k may be referred to as a strain energy component. The foldable strut 130-k may include one or more apertures 702 to facilitate folding; the strut 130-k may be made of a composite material and may be flattenable in some embodiments. In some embodiments, the strut 130-k may be replaced with a tape spring. Systems 700, 700-a, and 700-b may provide examples of aspects of system 200 of FIG. 2A and/or FIG. 2B. Heat pipe aspects 110-j may be an example of heat pipe aspects 110-i. Heat pipes 110-k and 110-l may be examples of heat pipes 110 of FIG. 1B, FIG. 1C, FIG. 2A, FIG. 2B, FIG. 3A, FIG. 3B, FIG. 3C, FIG. 5B, FIG. 6A, FIG. 6B, FIG. 6C, FIG. 6D, FIG. 6E, and/or FIG. 7A.

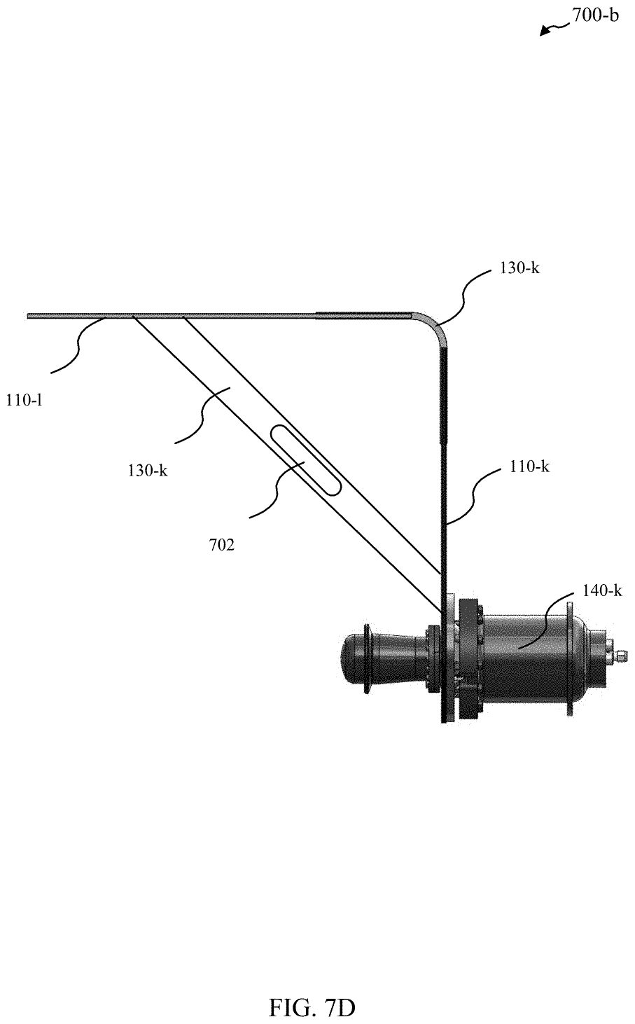

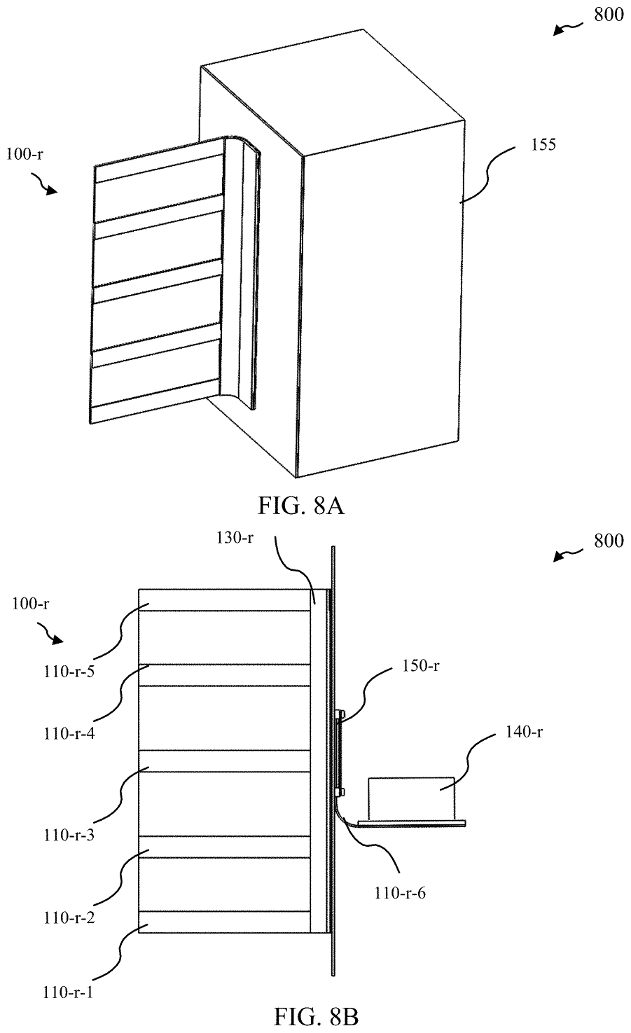

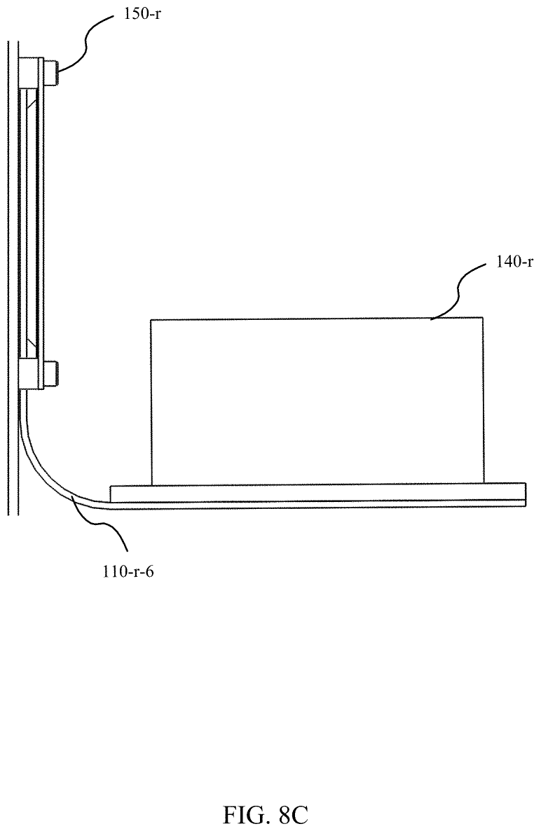

Turning now to FIG. 8A, FIG. 8B, and FIG. 8C, a system 800 is provided in accordance with various embodiments. System 800 may be an example of system 101 of FIG. 1A, FIG. 1C, and/or FIG. 1D, for example. In particular, system 800 may include a device 100-r that may include a radiator 120-r that may be coupled with multiple flat heat pipes 110-r-1, 110-r-2, 110-r-3, 110-r-4, and 110-r-5. Device 100-r may include a thermally-conductive, bendable hinge 130-r, which may be configured as a strain energy component to facilitate passive deployment of the radiator and heat pipe elements. Hinge 130-r may be a living hinge. Heat source 140-r may be coupled to the device 100-r through a thermal switch 150-r and a heat conductor, such as a heat strap or flexible heat pipe 110-r-6. The thermal switch 150-r may be configured such that the heat conductor 110-r-6 may be flexed to couple thermally with the device 100-r; these elements may be coupled thermally with each other through a bus structure 155, such as a satellite bus. Device 100-r may be an example of device 100 of FIG. 1A, FIG. 1B, FIG. 1C, FIG. 1D,

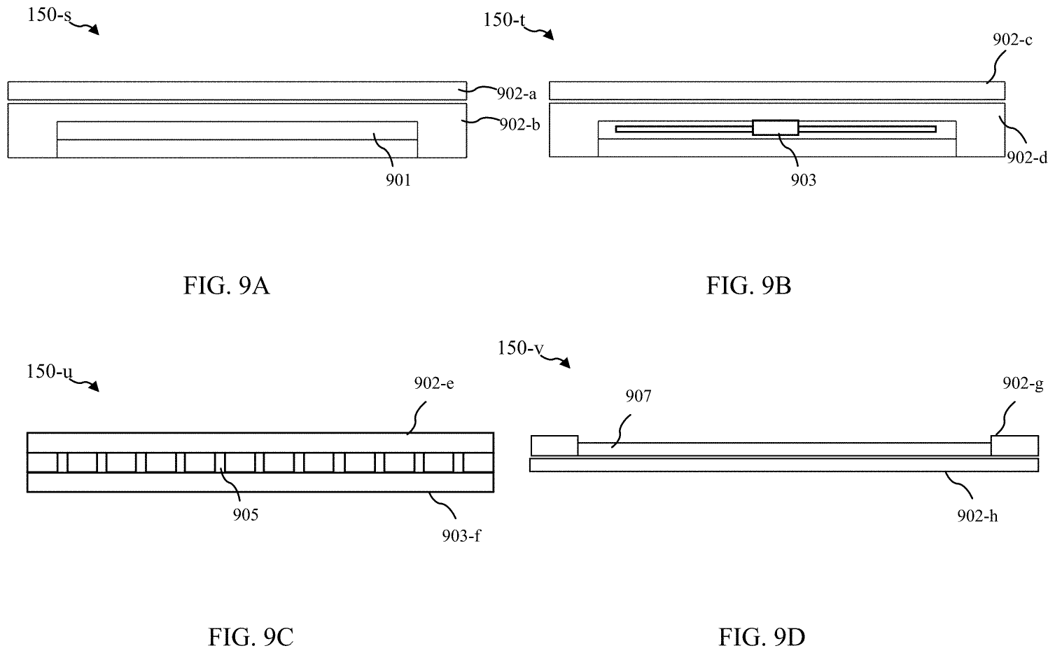

FIG. 9A, FIG. 9B, FIG. 9C, and FIG. 9D provide examples of thermal switches 150-s, 150-t, 150-u, and 150-v respectively, in accordance with various embodiments. These thermal switches may provide examples of the thermal switches 150 of FIG. 1D, FIG. 8A, FIG. 8B, and/or FIG. 8C. For example, FIG. 9A may provide a thermal switch 150-s that may utilize a phase change material. As the phase change material 901 undergoes a phase change and increases in volume as it is heated, one or more thermal contacts 902-a, 902-b of the thermal control circuit may move towards each other, completing a thermal circuit that may allow heat to pass from a heat source to a radiator, such as radiators 120, and/or heat pipes, such as heat pipes 110, shown with respect to devices 100 throughout the detailed description and figures. When the phase change material cools, the thermal circuit may be switched off as the contacts are separated. FIG. 9B shows another example of a thermal switch 150-t where a bi-metallic strip 903 may be utilized that may bend when it is heated, pushing a thermal contract 902-d to contact another thermal contact 902-c to complete a thermal circuit that may allow heat to pass from a heat source to a heat source to a radiator, such as radiators 120, and/or heat pipes, such as heat pipes 110, shown with respect to devices 100 throughout the detailed description and figures. When the bi-metallic strip 903 is cooled, the thermal circuit may be switched off as the contacts 902-d, 902-c are separated. The thermal switches of FIG. 9A and FIG. 9B may be referred to as passive thermal switches. FIG. 9C shows another example of thermal switch 150-u that may be configured as a thermoelectric switch utilizing one or more P-N junctions 904. When a current or voltage may be applied to the one or more junctions, a thermal gradient may be established with respect to the thermal contacts 902-e and 902-f of the thermal control circuit such that heat may pass from a heat source to a radiator, such as radiators 120, and/or heat pipes, such as heat pipes 110, shown with respect to devices 100 throughout the detailed description and figures. This thermoelectric switch may be referred to as an active switch. Another example of an active switch 150-v may be provided in FIG. 9D that may utilize a piezo-electric switch. When a current or voltage is applied, a piezoelectric diaphragm 907 may complete the thermal control circuit from thermal contact 902-g to thermal contact 902-h such that heat may pass from a heat source to a radiator, such as radiators 120, and/or heat pipes, such as heat pipes 110, shown with respect to devices 100 throughout the detailed description and figures. In some embodiments, the thermal switches 150-s, 150-t, 150-u, and/or 150-v may provide unidirectional circuits between other heat sources, such as heat sources on a spacecraft or other application, and a radiator, such as radiators 120, and/or heat pipes, such as heat pipes 110, shown with respect to devices 100 throughout the detailed description and figures.

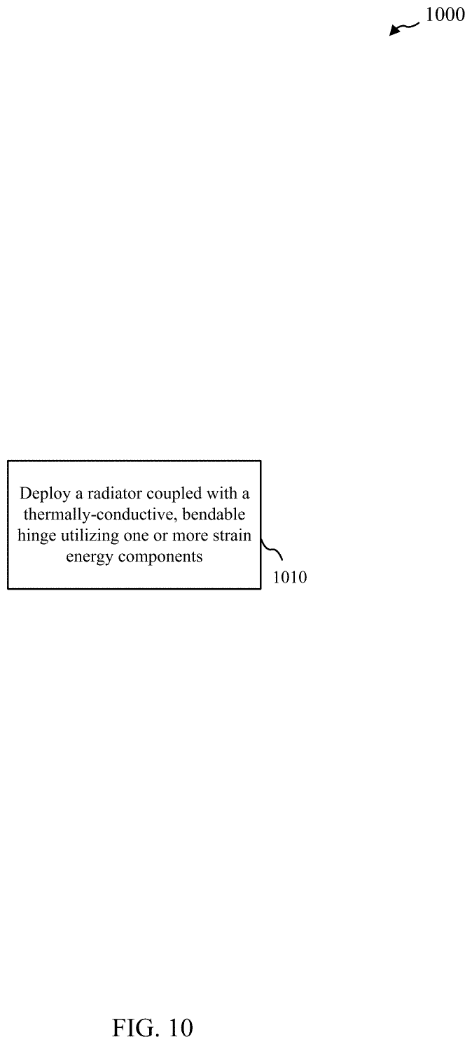

Turning now to FIG. 10, a flow diagram of a method 1000 is shown in accordance with various embodiments. Method 1000 may be implemented utilizing a variety of systems and/or devices such as those shown and/or described with respect to FIG. 1A, FIG. 1B, FIG. 1C, FIG. 1D, FIG. 2A, FIG. 2B, FIG. 3A, FIG. 3B, FIG. 3C, FIG. 4A, FIG. 4B, FIG. 5A, FIG. 5B, FIG. 6A, FIG. 6B, FIG. 6C, FIG. 6D, FIG. 6E, FIG. 7A, FIG. 7B, FIG. 7C, FIG. 7D, FIG. 8A, FIG. 8B, FIG. 8C, FIG. 9A, FIG. 9B, FIG. 9C, and/or FIG. 9D. At block 1010, a radiator coupled with a thermally-conductive, bendable hinge may be deployed utilizing a strain energy component. In some embodiments, the hinge may provide the strain energy for deployment. Some embodiments may utilize a strain energy component separate from the hinge. In some embodiments, heat may be conducted from a heat source to the radiator. In some embodiments, one or more thermal switches may be utilized to control the flow of heat from the heat source to the radiator.

In some embodiments, the heat passes from the heat source to a first flat heat pipe.

The first flat heat pipe may be coupled with the thermally-conductive, bendable hinge, for example, to facilitate the heat passing to a second flat heat pipe, which may be coupled with the radiator. In some embodiments, the radiator may include multiple pyrolytic graphite sheets. Some embodiments may utilize variations on these components to facilitate deployment of the device along with radiating heat that originates from a heat source. In some embodiments, the heat pipes may be constructed such that a vapor layer and a liquid layer are in a same plane of the heat pipe.

These embodiments may not capture the full extent of combination and permutations of materials and process equipment. However, they may demonstrate the range of applicability of the method, devices, and/or systems. The different embodiments may utilize more or less stages than those described.

It should be noted that the methods, systems and devices discussed above are intended merely to be examples. It must be stressed that various embodiments may omit, substitute, or add various procedures or components as appropriate. For instance, it should be appreciated that, in alternative embodiments, the methods may be performed in an order different from that described, and that various stages may be added, omitted or combined. Also, features described with respect to certain embodiments may be combined in various other embodiments. Different aspects and elements of the embodiments may be combined in a similar manner. Also, it should be emphasized that technology evolves and, thus, many of the elements are exemplary in nature and should not be interpreted to limit the scope of the embodiments.

Specific details are given in the description to provide a thorough understanding of the embodiments. However, it will be understood by one of ordinary skill in the art that the embodiments may be practiced without these specific details. For example, well-known circuits, processes, algorithms, structures, and techniques have been shown without unnecessary detail in order to avoid obscuring the embodiments.

Also, it is noted that the embodiments may be described as a process which may be depicted as a flow diagram or block diagram or as stages. Although each may describe the operations as a sequential process, many of the operations can be performed in parallel or concurrently. In addition, the order of the operations may be rearranged. A process may have additional stages not included in the figure.

Having described several embodiments, it will be recognized by those of skill in the art that various modifications, alternative constructions, and equivalents may be used without departing from the spirit of the different embodiments. For example, the above elements may merely be a component of a larger system, wherein other rules may take precedence over or otherwise modify the application of the different embodiments. Also, a number of stages may be undertaken before, during, or after the above elements are considered. Accordingly, the above description should not be taken as limiting the scope of the different embodiments.

What is claimed is:

1. A deployable radiator system comprising:
one or more radiators; and
one or more thermally-conductive, bendable hinges, wherein:
each respective thermally-conductive, bendable hinge from the one or more thermally-conductive, bendable hinges is coupled with a respective radiator from the one or more radiators; and
each respective thermally-conductive, bendable hinge from the one or more thermally-conductive, bendable hinges is configured to conduct heat to the respective radiator from the one or more radiators.

2. The system of claim 1, wherein the one or more thermally-conductive, bendable hinges include one or more strain energy components.

3. The system of claim 2, wherein the one or more strain energy components includes one or more high-strain composite laminates.

4. The system of claim 3, wherein the one or more high-strain composite laminates includes one or more curved regions for a deployed state of the respective radiator.

5. The system of claim 3, wherein the one or more high-strain composite laminates include an asymmetric composite laminate that changes shape with a temperature change.

6. The system of claim 1, wherein the one or more thermally-conductive, bendable hinges includes one or more thermally conductive composite laminates.

7. The system of claim 1, wherein each of the one or more radiators includes one or more thermally conductive layers.

8. The system of claim 7, wherein the one or more thermally conductive layers include one or more carbon layers.

9. The system of claim 8, wherein the one or more carbon layers includes at least one or more graphite layers or one or more graphene layers.

10. The system of claim 9, wherein at least the one or more graphite layers or the one or more graphene layers includes at least one or more pyrolytic graphite layers or one or more pyrolytic graphene layers.

11. The system of claim 7, wherein one or more of the one or more thermally conductive layers of the one or more radiators extend to form part of the one or more thermally-conductive, bendable hinges.

12. The system of claim 1, wherein at least one of the one or more radiators include one or more flat heat pipes.

13. The system of claim 12, wherein the one or more flat heat pipes are embedded between one or more thermally conductive layers of the at least one radiator.

14. The system of claim 12, wherein one or more flat heat pipes are coupled with a surface of the at least one radiator.

15. The system of claim 1, further comprising one or more heat pipes that are coupled with the one or more radiators utilizing the one or more thermally-conductive, bendable hinges.

16. The system of claim 15 , wherein the one or more heat pipes are configured to couple with one or more heat sources.

17. The system of claim 16, wherein each of the one or more heat pipes include a vapor layer and a liquid layer, wherein the vapor layer and the liquid layer are positioned within a same plane of the heat pipe.

18. The system of claim 17, wherein the one or more heat pipes include one or more slotted wicks.

19. The system of claim 18, wherein the one or more heat pipes include one or more slotted ribs, wherein the one or more slotted ribs support one or more of the slotted wicks.

20. The system of claim 18, wherein the one or more slotted wicks include a titanium foam.

21. The system of claim 15, wherein the one or more heat pipes include one or more through holes configured to couple the one or more heat pipes with the one or more heat sources.

22. The system of claim 1, further comprising one or more strain energy components coupled with the one or more radiators and configured to deploy the one or more radiators.

23. The system of claim 22, wherein the one or more strain energy components include at least one or more foldable struts or one or more tape springs.

24. The system of claim 1, further comprising one or more thermal switches positioned to control a flow of heat to the one or more radiators.

25. A heat pipe device comprising:
a first containment layers;
a second containment layer;
a vapor layer formed between the first containment layer and the second containment layer; and
a liquid layer formed between the first containment layer and the second containment layer, wherein the vapor layer and the liquid layer are within a same plane of the heat pipe device.

26. The device of claim 25, further comprising one or more slotted wicks.

27. The device of claim 26, further comprising one or more slotted ribs, wherein the one or more slotted ribs support one or more of the slotted wicks.

28. The device of claim 26, wherein the one or more slotted wicks include a titanium foam.

29. The device of claim 25, further comprising one or more through holes configured to couple the heat pipe device with one or more heat sources.

30. A method comprising:
deploying a radiator coupled with a thermally-conductive, bendable hinge utilizing one or more strain energy components.

31. The method of claim 30, wherein the thermally-conductive, bendable hinge includes the one or more strain energy components.

32. The method of claim 30, further comprising conducting heat to the radiator from a heat source through the thermally-conductive, bendable hinge.

33. The method of claim 32, further comprising conducting the heat from the heat source through one or more heat pipes coupled with at least the thermally-conductive, bendable hinge or the radiator.

34. The method of claim 33, wherein the one or more heat pipes each include a vapor layer and a liquid layer in a same plane of the respective heat pipe form the one or more heat pipes.
